(19) United States
(12) Patent Application Publication
(10) Pub. No.: US 2022/0161169 A1
(43) Pub. Date: May 26, 2022

(54) FILTER MEDIA COMPRISING NON-FLUORINATED WATER REPELLENT ADDITIVES

(71) Applicant: Hollingsworth & Vose Company, East Walpole, MA (US)

(72) Inventors: Dimitry Papkov, Clinton, MA (US); Phillip P. Carpenter, Gloucestershire (GB); Felix Ahrens, Battenberg (DE)

(73) Assignee: Hollingsworth & Vose Company, East Walpole, MA (US)

(21) Appl. No.: 17/101,707

(22) Filed: Nov. 23, 2020

(51) Int. Cl. B01D 39/18; B01D 39/20; B01D 39/16

(52) U.S. Cl. CPC B01D 39/18; B01D 39/2024; B01D 2239/1233; B01D 2239/0428; B01D 2239/0618; B01D 39/163

(57) ABSTRACT

Filter media comprising water-repellent additives having minimal or no fluorine atoms are generally provided. In some embodiments, the water-repellent additives comprise one or more water-repellent functional groups. The water-repellent functional groups may comprise a carbon chain including three or more carbon atoms. In some embodiments, some or all of the water-repellent functional group(s) are bonded to a silicon atom and/or a metal atom. It is also possible for some or all of the water-repellent functional group(s) to form side chain(s) attached to a polymer backbone.

### FIELD

The present invention relates generally to filter media, and, more particularly, to filter media comprising non-fluorinated water repellent additives

### BACKGROUND

Filter media may be employed in a variety of applications to remove contaminants from fluids. Some such filter media include fluorinated water repellents. However, new regulations may make such water repellents challenging to use.

Accordingly, improved filter media designs are needed.

### SUMMARY

Filter media, related components, and related methods are generally described.

In some embodiments, a filter media is provided. The filter media comprises a non-woven fiber web and a water-repellent additive. The water-repellent additive comprises one or more water-repellent functional groups. Each water-repellent functional group is independently an alkyl group comprising greater than or equal to 3 carbon atoms, an alkenyl group comprising greater than or equal to 3 carbon atoms, and/or an alkynyl group comprising greater than or equal to 3 carbon atoms. Each water-repellent functional group is independently a side chain of a repeat unit of a polymer and/or bonded to a silicon atom and/or a metal atom. The filter media has a gamma of greater than 6. The filter media has a water repellency of greater than 4 inches H₂O.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 shows a filter media comprising a non-woven fiber web, in accordance with some embodiments;

FIG. 2 shows a filter media comprising a non-woven fiber web and a layer, in accordance with some embodiments;

FIG. 3 shows gamma values for various filter media, in accordance with some embodiments; and

FIGS. 4-5 show water repellency values for various filter media, in accordance with some embodiments.

### DETAILED DESCRIPTION

Filter media comprising water-repellent additives having minimal or no fluorine atoms are generally provided. In some embodiments, the water-repellent additives comprise one or more water-repellent functional groups. The water-repellent functional groups may comprise a carbon chain including three or more carbon atoms. In some embodiments, some or all of the water-repellent functional group(s) are bonded to a silicon atom and/or a metal atom. It is also possible for some or all of the water-repellent functional group(s) to form side chain(s) attached to a polymer backbone.

Some filter media described herein may exhibit improved properties in comparison to filter media comprising other types of water-repellent additives, such as water-repellent additives including an appreciable amount of fluorine and/or lacking a water-repellent functional group taking the form of a carbon chain including three or more carbon atoms. For instance, in some embodiments, a filter media described herein include fewer (or zero) components that are subject to certain regulations by a government body. Such filter media may exhibit comparable to or better performance than filter media comprising such regulated water-repellent additives. Such filter media may exhibit better performance than filter media comprising other types of non-fluorinated water-repellent additives, such as non-fluorinated water-repellent additives lacking a functional group taking the form of a carbon chain comprising three or more carbon atoms.

In some embodiments, a filter media described herein comprises an additive comprising a polar functional group. The polar functional group may be present in the same additive that also comprises a water-repellent functional group and/or may be present in a different additive. Advantageously, and unexpectedly, the presence of such polar functional groups may enhance the water-repellency of the filter media in comparison to otherwise-equivalent filter media lacking the additive comprising such polar functional groups and/or lacking such polar functional groups.

Some filter media described herein comprise a water-repellent additive including minimal or no fluorine and also comprise a resin. The water-repellent additive and the resin may together enhance the properties of the filter media in a manner that would be unexpected based on the performance of each of the water-repellent additive and the resin on its own. For instance, the combination of a water-repellent additive that exhibits appreciable water-repellency on its own and a resin that exhibits minimal water-repellency on its own may together exhibit notably higher water-repellency than the water-repellent additive.

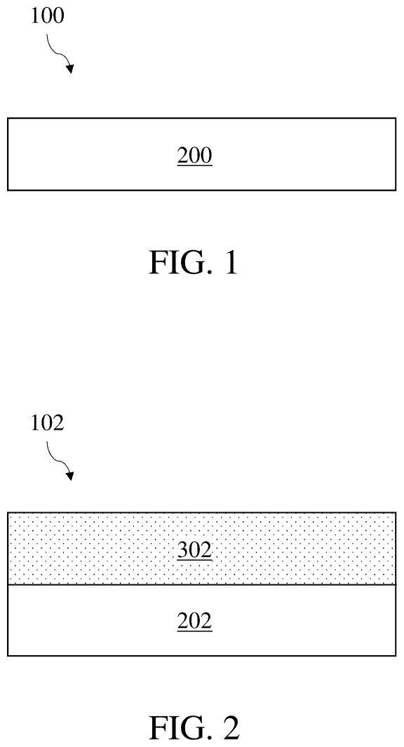

As described above, in some embodiments, a filter media is provided. FIG. 1 shows one non-limiting embodiment of a filter media 100 comprising a non-woven fiber web 200. Some filter media, like the filter media shown in FIG. 1, may include exactly one layer and/or non-woven fiber web. It is also possible for a filter media to comprise two or more layers (e.g., three or more layers, four or more layers, more than four layers), some or all of which may be non-woven fiber webs. A filter media may comprise two or more layers that are of the same type and/or may comprise two or more layers that are of different types. FIG. 2 shows one example of a filter media 102 comprising a non-woven fiber web 202 and a layer 302.

As also described above, in some embodiments, a filter media comprises one or more water-repellent additives and/or one or more resins. Each water-repellent additive and resin present in the filter media (if present) may independently be present in one or more of the layers present in the filter media (e.g., dispersed therethrough evenly or unevenly) and/or present in the form of a coating and/or surface layer disposed on one or more of the layers present in the filter media. With respect to FIG. 2, each of the water-repellent additives and resins present in the filter media (if any are present) may independently be positioned in the non-woven fiber web 202, the layer 302, at the surface of the non-woven fiber web 202 opposite the layer 302 (e.g., in the form of a coating and/or surface layer), between the non-woven fiber web 202 and the layer 302, and/or at the surface of the layer 302 opposite the non-woven fiber web 202.

Water-repellent additives suitable for inclusion in the filter media described herein may have a variety of suitable properties. In some embodiments, a filter media comprises a water-repellent additive that has a water-repellent functional group. An additive of this type may be in the form of a resin or may be in a different form. It is also possible for a filter media to further comprise one or more additives of a different type (e.g., one or more additives that are not water-repellent, one or more additives that comprise fluorine, one or more additives that are regulated by a government body) and/or to comprise one or more resins that are not water-repellent (e.g., in addition to a water-repellent additive that is a resin, in addition to a water-repellent additive that is not a resin). Further details regarding some suitable water-repellent additives are provided below.

When present, a water-repellent additive may make up a variety of suitable amounts of the filter media. In some embodiments, a water-repellent additive makes up greater than or equal to 0.001 wt %, greater than or equal to 0.002 wt %, greater than or equal to 0.005 wt %, greater than or equal to 0.0075 wt %, greater than or equal to 0.01 wt %, greater than or equal to 0.02 wt %, greater than or equal to 0.05 wt %, greater than or equal to 0.075 wt %, greater than or equal to 0.1 wt %, greater than or equal to 0.2 wt %, greater than or equal to 0.5 wt %, greater than or equal to 0.75 wt %, greater than or equal to 1 wt %, greater than or equal to 2 wt %, greater than or equal to 5 wt %, greater than or equal to 7.5 wt %, greater than or equal to 10 wt %, greater than or equal to 15 wt %, greater than or equal to 20 wt %, greater than or equal to 25 wt %, greater than or equal to 30 wt %, or greater than or equal to 40 wt % of the filter media. In some embodiments, a water-repellent additive makes up less than or equal to 50 wt %, less than or equal to 40 wt %, less than or equal to 30 wt %, less than or equal to 25 wt %, less than or equal to 20 wt %, less than or equal to 15 wt %, less than or equal to 10 wt %, less than or equal to 7.5 wt %, less than or equal to 5 wt %, less than or equal to 2 wt %, less than or equal to 1 wt %, less than or equal to 0.75 wt %, less than or equal to 0.5 wt %, less than or equal to 0.2 wt %, less than or equal to 0.1 wt %, less than or equal to 0.075 wt %, less than or equal to 0.05 wt %, less than or equal to 0.02 wt %, less than or equal to 0.01 wt %, less than or equal to 0.0075 wt %, less than or equal to 0.005 wt %, or less than or equal to 0.002 wt % of the filter media. Combinations of the above-referenced ranges are also possible (e.g., greater than or equal to 0.001 wt % and less than or equal to 50 wt %, greater than or equal to 0.001 wt % and less than or equal to 25 wt %, greater than or equal to 0.001 wt % and less than or equal to 10 wt %, greater than or equal to 0.1 wt % and less than or equal to 50 wt %, or greater than or equal to 0.5 wt % and less than or equal to 50 wt %). Other ranges are also possible.

In embodiments in which a filter media comprises two or more water-repellent additives, each water-repellent additive may independently be present in the filter media in one or more of the ranges described above. It is also possible for the total amount of water-repellent additives present in the filter media to be in one or more of the ranges described above (i.e., a filter media may comprise one, two, or more additives, and all of the additives together may make up an amount of the filter media in one or more of the ranges described above).

As described above, in some embodiments, a water-repellent additive is present in a layer of a filter media and/or in a coating disposed on one or more layers present in a filter media. In such embodiments, the water-repellent additive may be bonded to one or more components of the layer. As an example, in some embodiments, a water-repellent additive is bonded to at least a portion of the fibers in a fibrous layer (e.g., a non-woven fiber web). A variety of suitable types of bonding may be present. For instance, the bonding may be covalent bonding, ionic bonding, metallo-organic bonding, and/or hydrogen bonding. It is also possible for the water-repellent additive(s) to be physically entrapped in a layer and/or mechanically coupled to a layer without being bonded thereto.

In some embodiments, a water-repellent additive comprises one or more water-repellent functional groups having a carbon chain including greater than or equal to three carbon atoms. Each such functional group may independently be an alkyl group (i.e., a saturated carbon chain), an alkenyl group, or an alkynyl group. The alkenyl groups and alkynyl groups described herein may have any suitable degree of unsaturation. For instance, an alkenyl group may include exactly one double bond, may include two or more double bonds, or may include exclusively double bonds connecting the carbons in the alkenyl chain. Similarly, an alkynyl group may include exactly one triple bond, may include two or more triple bonds, or may include exclusively alternating triple and single bonds along the alkynyl chain. In some embodiments, an alkynyl group includes one or more triple bonds and one or more double bonds. When multiple double bonds and/or triple bonds are present, they may be positioned with respect to each other in any suitable manner. For instance, two double bonds may be adjacent or separated by one or more bonds of another type. Similarly, two triple bonds may be separated by exactly one single bond or may be separated by two or more bonds of another type.

The alkyl groups, alkenyl groups, and alkynyl groups described herein may have a variety of suitable architectures. Some suitable alkyl groups, alkenyl groups, and alkynyl groups are unbranched and/or straight chain functional groups, and some suitable alkyl groups, alkenyl groups, and alkynyl groups are branched and/or hyperbranched. Branched alkyl groups, alkenyl groups, and alkynyl groups may be branched at a single location or at multiple locations. When branched at multiple locations, the branches may be equally spaced or unequally spaced. Similarly, an alkyl group, alkenyl group, or alkynyl group may comprise two or more branches having equal lengths and/or may comprise two or more branches having unequal lengths.

A water-repellent additive may comprise an alkyl group that is unsubstituted, alkenyl group that is unsubstituted, and/or alkynyl group that is unsubstituted. It is also possible for a water-repellent additive to comprise an alkyl group that is substituted, an alkenyl group that is substituted, and/or an alkynyl group that is substituted. Substituted functional groups may be singly substituted (i.e., they may be substituted in a single location) and/or may be substituted in one or more locations. One non-limiting example of a suitable substitution is an aryl group.

The alkyl groups, alkenyl groups, and alkynyl groups described herein may have a variety of suitable lengths. When present, the alkyl group(s), alkenyl group(s), and/or alkynyl group(s) may each independently comprise greater than or equal to 3 carbon atoms, greater than or equal to 4 carbon atoms, greater than or equal to 5 carbon atoms, greater than or equal to 6 carbon atoms, greater than or equal to 7 carbon atoms, greater than or equal to 8 carbon atoms, greater than or equal to 9 carbon atoms, greater than or equal to 10 carbon atoms, greater than or equal to 11 carbon atoms, greater than or equal to 12 carbon atoms, greater than or equal to 13 carbon atoms, greater than or equal to 14 carbon atoms, greater than or equal to 15 carbon atoms, greater than or equal to 16 carbon atoms, greater than or equal to 17 carbon atoms, greater than or equal to 18 carbon atoms, greater than or equal to 19 carbon atoms, greater than or equal to 20 carbon atoms, greater than or equal to 21 carbon atoms, greater than or equal to 22 carbon atoms, greater than or equal to 23 carbon atoms, greater than or equal to 24 carbon atoms, greater than or equal to 25 carbon atoms, greater than or equal to 26 carbon atoms, greater than or equal to 27 carbon atoms, greater than or equal to 28 carbon atoms, or greater than or equal to 29 carbon atoms. The alkyl group(s), alkenyl group(s), and/or alkynyl group(s) may each independently comprise less than or equal to 30 carbon atoms, less than or equal to 29 carbon atoms, less than or equal to 28 carbon atoms, less than or equal to 27 carbon atoms, less than or equal to 26 carbon atoms, less than or equal to 25 carbon atoms, less than or equal to 24 carbon atoms, less than or equal to 23 carbon atoms, less than or equal to 22 carbon atoms, less than or equal to 21 carbon atoms, less than or equal to 20 carbon atoms, less than or equal to 19 carbon atoms, less than or equal to 18 carbon atoms, less than or equal to 17 carbon atoms, less than or equal to 16 carbon atoms, less than or equal to 15 carbon atoms, less than or equal to 14 carbon atoms, less than or equal to 13 carbon atoms, less than or equal to 12 carbon atoms, less than or equal to 11 carbon atoms, less than or equal to 10 carbon atoms, less than or equal to 9 carbon atoms, less than or equal to 8 carbon atoms, less than or equal to 7 carbon atoms, less than or equal to 6 carbon atoms, less than or equal to 5 carbon atoms, or less than or equal to 4 carbon atoms. Combinations of the above-referenced ranges are also possible (e.g., greater than or equal to 3 carbon atoms and less than or equal to 30 carbon atoms, or greater than or equal to 8 carbon atoms and less than or equal to 30 carbon atoms). Other ranges are also possible.

In some embodiments, a water-repellent additive comprises a water-repellent functional group having a number of carbon atoms identically equal to any of the values in the preceding paragraph (e.g., identically equal to three carbon atoms, identically equal to four carbon atoms, identically equal to five carbon atoms, etc.).

In some embodiments, a water-repellent functional group that is an alkyl group, alkenyl group, or alkynyl group comprises a number of carbon atoms in one or more of the above-referenced ranges that are arranged in a linear chain (e.g., an alkyl group comprising greater than or equal to 3 carbon atoms and less than or equal to 30 carbon atoms may be an n-alkyl group, an alkyl group comprising identically 8 carbon atoms may be an n-octyl group). It is also possible for the alkyl group, alkenyl group, or alkynyl group to comprise a carbon chain comprising a number of carbon atoms in one or more of the above-referenced ranges and further comprise one or more branches comprising further carbon atoms (e.g., an alkyl group may comprise a carbon chain comprising greater than or equal to 3 carbon atoms and less than or equal to 30 carbon atoms which may comprise one or more branches comprising further carbon atoms). In some embodiments, an alkyl group, alkenyl group, or alkynyl group comprises a number of carbon atoms in one or more of the above-referenced ranges that are not arranged in a linear chain (e.g., an alkyl group comprising identically 10 carbon atoms may be an ethyl-substituted octyl group).

It should also be understood that, for water-repellent additives comprising two or more water-repellent functional groups that each comprise three or more carbon atoms, the water-repellent functional groups that each comprise three or more carbon atoms may all be identical, may comprise at least one pair of such water-repellent functional groups that are identical to each other and at least one pair of such water-repellent functional groups that differ from each other, or may not comprise any such water-repellent functional groups that are identical to each other. Additionally, it should also be understood that some filter media may comprise two or more water-repellent additives that are different from each other but that each comprise at least one water-repellent functional group that comprises a carbon chain comprising three or more carbon atoms.

Some water-repellent additives include minimal or no fluorine atoms. In other words, in some embodiments, a filter media comprises a water-repellent additive that lacks fluorine atoms and/or includes relatively few fluorine atoms. In some embodiments, a filter media comprises a water-repellent additive that comprises a water-repellent functional group (e.g., an alkyl group comprising greater than or equal to three carbon atoms, an alkenyl group comprising greater than or equal to three carbon atoms, an alkynyl group comprising greater than or equal to three carbon atoms) that lacks fluorine atoms and/or includes relatively few fluorine atoms. For instance, fluorine atoms may make up less than or equal to 100 at %, less than or equal to 90 at %, less than or equal to 80 at %, less than or equal to 70 at %, less than or equal to 60 at %, less than or equal to 50 at %, less than or equal to 40 at %, less than or equal to 30 at %, less than or equal to 20 at %, less than or equal to 10 at %, less than or equal to 7.5 at %, less than or equal to 5 at %, less than or equal to 4 at %, less than or equal to 3 at %, or less than or equal to 2 at % of the atoms bonded to the carbon atoms in a water-repellent functional group. Fluorine atoms may make up greater than or equal to 1.5 at %, greater than or equal to 2 at %, greater than or equal to 3 at %, greater than or equal to 4 at %, greater than or equal to 5 at %, greater than or equal to 7.5 at %, greater than or equal to 10 at %, greater than or equal to 20 at %, greater than or equal to 30 at %, greater than or equal to 40 at %, greater than or equal to 50 at %, greater than or equal to 60 at %, greater than or equal to 70 at %, greater than or equal to 80 at %, or greater than or equal to 90 at % of the atoms bonded to the carbon atoms in a water-repellent functional group. Combinations of the above-referenced ranges are also possible (e.g., greater than or equal to 1.5 at % and less than or equal to 100 at %). Other ranges are also possible. In some embodiments, fluorine atoms make up identically 0% of the atoms bonded to the carbon atoms in a water-repellent functional group.

It should also be understood that, for water-repellent additives comprising two or more water-repellent functional groups, each water-repellent functional group may independently include an amount of fluorine in one or more of the above-referenced ranges. Additionally, it should also be understood that some filter media may comprise two or more water-repellent additives that are different from each other but that each comprise at least one water-repellent functional group that includes an amount of fluorine in one or more of the above-referenced ranges.

In some embodiments, a water-repellent additive comprises a water-repellent functional group (e.g., an alkyl group comprising greater than or equal to three carbon atoms, an alkenyl group comprising greater than or equal to three carbon atoms, an alkynyl group comprising greater than or equal to three carbon atoms) that includes less than or equal to 7 fluorine atoms, less than or equal to 6 fluorine atoms, less than or equal to 5 fluorine atoms, less than or equal to 4 fluorine atoms, less than or equal to 3 fluorine atoms, less than or equal to 2 fluorine atoms, or less than or equal to one fluorine atom. In some embodiments, a water-repellent additive comprises a water-repellent functional group that includes greater than or equal to 0 fluorine atoms, greater than or equal to 1 fluorine atom, greater than or equal to 2 fluorine atoms, greater than or equal to 3 fluorine atoms, greater than or equal to 4 fluorine atoms, greater than or equal to 5 fluorine atoms, or greater than or equal to 6 fluorine atoms. Combinations of the above-referenced ranges are also possible (e.g., greater than or equal to 0 fluorine atoms and less than or equal to 7 fluorine atoms). Other ranges are also possible. Additionally, in some embodiments, a water-repellent functional group includes identically 0 fluorine atoms.

It should also be understood that, for water-repellent additives comprising two or more water-repellent functional groups, each water-repellent functional group may independently include an amount of fluorine in one or more of the above-referenced ranges. Additionally, it should also be understood that some filter media may comprise two or more water-repellent additives that are different from each other but that each comprise at least one water-repellent functional group that includes an amount of fluorine in one or more of the above-referenced ranges.

In some embodiments, a water-repellent additive comprising a water-repellent functional group (e.g., an alkyl group comprising greater than or equal to three carbon atoms, an alkenyl group comprising greater than or equal to three carbon atoms, an alkynyl group comprising greater than or equal to three carbon atoms) further comprises a silicon atom and/or a metal atom. The water-repellent functional group may be bonded to the silicon atom and/or the metal atom. For instance, in some embodiments, a water-repellent additive has one or both of the structures shown below:

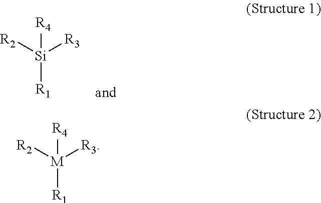

In Structures 1 and 2, R₁ is a water-repellent functional group (e.g., that is and/or comprises an alkyl group comprising greater than or equal to three carbon atoms, an alkenyl group comprising greater than or equal to three carbon atoms, or an alkynyl group comprising greater than or equal to three carbon atoms). Additionally, R₂, R₃, and R₄ are any suitable functional groups. As described above, in some embodiments, one, two, or all of R₂, R₃, and R₄ are also water-repellent functional groups (e.g., having the same structure as R₁ and/or each other, having a different structure from R₁ and/or each other). In other words, a water-repellent additive may comprise two water-repellent functional groups both bonded to the same silicon or metal atom. It is also possible for one, two, or all of R₂, R₃, and R₄ to be a functional group other than a water-repellent functional group (e.g., having the same structures as each other, having different structures from each other). Further detail regarding suitable structures for R₂, R₃, and R₄ are provided elsewhere herein.

In the embodiments in which a water-repellent additive has a structure as shown in Structure 2, M may be a variety of suitable metals. In some embodiments, M is a post-transition metal (e.g., aluminum). It is also possible for M to be a transition metal (e.g., titanium, zirconium).

Further examples of suitable water-repellent additives are shown below:

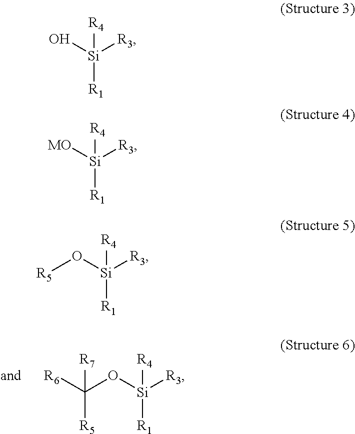

Structures 3-6 depict silanols, siloxides, silyl ethers, and silanes, respectively. In Structures 3-6: R₁ is a water-repellent functional group (e.g., an alkyl group comprising greater than or equal to three carbon atoms, an alkenyl group comprising greater than or equal to three carbon atoms, an alkynyl group comprising greater than or equal to three carbon atoms); and R₃ and R₄ are any suitable functional groups. In Structure 4, M is a metal (e.g., a post-transition metal such as aluminum, a transition metal such as titanium or zirconium). In Structures 5 and 6, R₅ is any suitable functional group. In Structure 6, R₆ and R₇ are any suitable functional groups. In some embodiments, one, two, or all of R₃, R₄, R₅, R₆, and R₇ (when present) are also water-repellent functional groups (e.g., having the same structure as R₁ and/or each other, having a different structure from R₁ and/or each other). It is also possible for one, two, or all of R₃, R₄, R₅, R₆, and R₇ to be a functional group other than a water-repellent functional group (e.g., having the same structures as each other, having different structures from each other).

In some embodiments, a water-repellent additive comprising a water-repellent functional group (e.g., an alkyl group comprising greater than or equal to three carbon atoms, an alkenyl group comprising greater than or equal to three carbon atoms, an alkynyl group comprising greater than or equal to three carbon atoms) is a polymer. In such embodiments, the water-repellent functional group may form a side chain of a repeat unit of the polymer. As an example, a water-repellent additive may have the following structure:

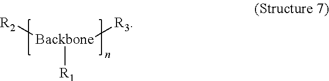

In Structure 7: Backbone is one or more atoms that form part of the backbone of the polymer; R₁ is a water-repellent functional group (e.g., that is and/or comprises an alkyl group comprising greater than or equal to three carbon atoms, an alkenyl group comprising greater than or equal to three carbon atoms, or an alkynyl group comprising greater than or equal to three carbon atoms); R₂ and R₃ are any suitable end groups; and n is any suitable value. Neither, either, or both of R₂ and R₃ may be water-repellent functional groups. In some embodiments, one or more further side chains may also be bonded to Backbone (not shown). Some, none, or all of such side chains may also be water-repellent. Additionally, some, none, or all of such further side chains may be bonded to the same atom as the water-repellent functional group.

A variety of suitable backbones may be employed. In some embodiments, the backbone is formed from carbon atoms. It is also possible for the backbone to comprise one or more heteroatoms (e.g., silicon atoms, oxygen atoms, nitrogen atoms).

Non-limiting examples of suitable repeat units (i.e., including both the backbone and the water-repellent functional group) include polymerized acrylic repeat units (e.g., the polymer may be a poly(acrylate)), polymerized urethane repeat units (e.g., the polymer may be a poly(urethane)), polymerized epoxy repeat units (e.g., the polymer may be a poly(ether)), polymerized urea repeat units (e.g., the polymer may be a poly(urea)), polymerized ester repeat units (e.g., the polymer may be a poly(ester)), polymerized siloxane repeat units (e.g., the polymer may be a poly(siloxane)), polymerized silazane repeat units (e.g., the polymer may be a poly(silazane)), and polymerized carbodiimide repeat units (e.g., the polymer may be a poly(carbodiimide)).

Further examples of suitable polymers include hydrolysis products of species comprising a metal atom, a hydrolysable functional group, and one or more water-repellent functional groups (e.g., that are and/or comprise alkyl groups comprising greater than or equal to three carbon atoms, alkenyl groups comprising greater than or equal to three carbon atoms, and/or alkynyl groups comprising greater than or equal to three carbon atoms). These species may comprise post-transition metals (e.g., aluminum) and/or transition metals (e.g., titanium, zirconium). The hydrolysis products may take the form of organometallic compounds (e.g., organoaluminum compounds, organotitanium compounds, and/or organozirconium compounds).

In some embodiments, like the embodiment shown in Structure 7, a water-repellent additive comprising a water-repellent functional group is a homopolymer. It is also possible for a filter media to comprise a water-repellent additive that is a polymer other than a homopolymer. For instance, in some embodiments, a water-repellent additive comprises a repeat unit comprising a side chain comprising a water-repellent functional group (e.g., an alkyl group comprising greater than or equal to three carbon atoms, an alkenyl group comprising greater than or equal to three carbon atoms, an alkynyl group comprising greater than or equal to three carbon atoms) and further comprises one or more different types of repeat units. The different type(s) of repeat units may comprise a repeat unit comprising a water-repellent functional group (e.g., of a different type than the first repeat unit comprising a water-repellent functional group, of the same type as the first repeat unit comprising a water-repellent functional group but attached to a different type of backbone) and/or may comprise a repeat unit lacking a water-repellent functional group.

A water-repellent additive may be a copolymer, such as a dipolymer, a terpolymer, a quaterpolymer, or any other suitable type of polymer. Additionally, the arrangement of the repeat units within a copolymer may generally be selected as desired. To provide non-limiting examples, suitable water-repellent additives may include random copolymers, alternating copolymers, periodic copolymers, statistical copolymers, block copolymers, blocky copolymers, stereoblock copolymers, tapered copolymers, and/or graft copolymers. Structures 8 and 9 below show two non-limiting examples of suitable random copolymers and block copolymers, respectively:

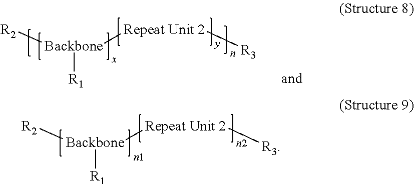

In Structures 8 and 9: Backbone is one or more atoms that form part of the backbone of the polymer associated with a repeat unit comprising a water-repellent functional group; Repeat Unit 2 is a repeat unit copolymerized with the repeat unit comprising the water-repellent functional group; R₁ is a water-repellent functional group (e.g., that is and/or comprises an alkyl group comprising greater than or equal to three carbon atoms, an alkenyl group comprising greater than or equal to three carbon atoms, or an alkynyl group comprising greater than or equal to three carbon atoms); and R₂ and R₃ are any suitable end groups. In Structure 8: n is any suitable value; x and y may be selected as desired and may vary across the length of the polymer. In Structure 9: n1 and n2 may be selected as desired. Neither, either, or both of R₂ and R₃ may be water-repellent functional groups. Similarly, the repeat unit comprising Backbone may comprise one or more further water-repellent functional groups and/or Repeat Unit 2 may comprise one or more water-repellent functional groups.

For both Backbone and Repeat Unit 2, a variety of suitable backbones may be employed. In some embodiments, the backbone is formed from carbon atoms. It is also possible for the backbone to comprise one or more heteroatoms (e.g., silicon atoms, oxygen atoms, nitrogen atoms).

Non-limiting examples of suitable repeat units for both the repeat unit comprising R₁ and Repeat Unit 2 include polymerized acrylic repeat units (e.g., the polymer may be a poly(acrylate)), polymerized urethane repeat units (e.g., the polymer may be a poly(urethane)), polymerized epoxy repeat units (e.g., the polymer may be a poly(ether)), polymerized siloxane repeat units (e.g., the polymer may be a poly(siloxane)), and polymerized silazane repeat units (e.g., the polymer may be a poly(silazane)).

It is also possible for a water-repellent additive to be an oligomer and comprise a water-repellent functional group (e.g., an alkyl functional group comprising greater than or equal to three carbon atoms, an alkenyl functional group comprising greater than or equal to three carbon atoms, an alkynyl functional group comprising greater than or equal to three carbon atoms). For instance, in some embodiments, a water-repellent additive is an oligomer that has a structure shown in any of Structures 7-9 in which n, x, or the sum of n1 and n2 is small enough to make the molecule an oligomer.

In some embodiments, a water-repellent additive has a three-dimensional structure. For instance, in some embodiments, a water-repellent additive is a covalent network. The covalent network may be crystalline, amorphous, or semicrystalline. Water-repellent additives having three-dimensional structures may comprise one or more water-repellent functional group(s) (e.g., alkyl functional groups comprising greater than or equal to three carbon atoms, alkenyl functional groups comprising greater than or equal to three carbon atoms, alkynyl functional groups comprising greater than or equal to three carbon atoms). It is also possible for such water-repellent additives to also comprise other types of functional groups. In some embodiments, water-repellent additives that are three-dimensional structures further comprise silicon atoms, metal atoms (e.g., titanium atoms, zirconium atoms, and/or aluminum atoms), oxygen atoms, and/or nitrogen atoms. In some such embodiments, the metal and/or silicon atoms may bond to both the oxygen atoms and the water-repellent functional groups. One non-limiting example of a suitable covalent network is a silsesquioxane.

In some embodiments, a water-repellent additive comprising a water-repellent functional group (e.g., an alkyl functional group comprising greater than or equal to three carbon atoms, an alkenyl functional group comprising greater than or equal to three carbon atoms, an alkynyl functional group comprising greater than or equal to three carbon atoms) further comprises one or more polar functional groups. The polar functional group(s) may be non-hydrolysable functional group(s) and/or functional group(s) that are stable during filter media preparation and/or use. Non-limiting examples of suitable polar functional groups include amino groups, acetoxy groups, and acetamido groups. Additionally, when a water-repellent additive comprises two or more polar functional groups, it may comprise exclusively one type of polar functional group, exclusively different types of polar functional groups, or at least two polar functional groups of the same type and at least two polar functional groups of different types.

When present, the polar functional group(s) may be positioned in a variety of suitable locations in the water-repellent additives described herein. For instance, in a water-repellent additive comprising a silicon or metal atom to which a water-repellent functional group is bonded, it is possible for the polar functional group to also be bonded to the silicon or metal atom. With reference to Structures 1 and 2, it is possible for all, some, or none of R₂, R₃, and R₄ to be polar functional groups. Similarly, with reference to Structures 3-6, it is also possible for all, some, or none of R₃, R₄, R₅, R₆, and R₇ to be polar functional groups.

In some embodiments, a water-repellent additive that is oligomeric or polymeric comprises a polar functional group. As an example, a water-repellent additive comprising an oligomer or polymer that comprises a repeat unit that comprises a water-repellent functional group (e.g., an alkyl group comprising greater than or equal to three carbon atoms, an alkenyl group comprising greater than or equal to three carbon atoms, an alkynyl group comprising greater than or equal to three carbon atoms) may further comprise a polar functional group. With reference to Structure 7-9, it is possible for a polar functional group to be attached to Backbone and/or for either, both, or neither of R₂ and R₃ to be polar functional groups. When the polar functional group is attached to Backbone, it may or may not be directly attached to the same atom therein to which the water-repellent functional group is attached. With reference to Structures 8 and 9, it is possible for a polar functional group to be attached to Repeat Unit 2. In other words, a polymeric or oligomeric water-repellent additive may: comprise a repeat unit comprising a single atom to which both a polar functional group and a water-repellent functional group are bonded; comprise a repeat unit comprising a polar functional group bonded to a different backbone atom than a water-repellent functional group; comprise one repeat unit comprising a water-repellent functional group and a second, different repeat unit comprising a polar functional group; and/or comprise an end group that comprises a polar functional group.

In some embodiments, a water-repellent additive that is a covalent network comprises one or more polar functional groups (e.g., in addition to a water-repellent functional group).

It should also be stated that some water-repellent additives (e.g., those having a structure shown in one or more of Structures 1-9, those comprising a silicon atom and/or a metal atom, those that are polymeric, those that are oligomeric, those that are covalent networks) may comprise one or more functional groups that are not water-repellent functional groups and are not polar functional groups. Such functional groups may be positioned in any suitable location(s) (e.g., any location(s) in Structures 1-9 that are not water-repellent functional groups or polar functional groups). Non-limiting examples functional groups that are neither a water-repellent functional group as described herein nor a polar functional group include hydrogen, methyl groups, and ethyl groups.

In some embodiments, a filter media comprises an additive comprising a polar functional group (e.g., a polar functional group as described elsewhere herein as being suitable for inclusion in a water-repellent additive). The additive comprising the polar functional group may also be a water-repellent additive (e.g., as described elsewhere herein) and/or comprise a water-repellent functional group (e.g., an alkyl group comprising greater than or equal to three carbon atoms, an alkenyl group comprising greater than or equal to three carbon atoms, an alkynyl group comprising greater than or equal to three carbon atoms). It is also possible for the additive comprising the polar functional group to lack water-repellent functional groups. An additive comprising a polar functional group may have a structure similar to one or more of the structures shown in Structures 1-9 and differing therefrom only in that R₁ is not a water-repellent functional group and one or more of the functional groups present (e.g., some or all of R₁-R₉) are polar functional groups.

When a filter media comprises a water-repellent additive and/or combination of additives (e.g., a combination of water-repellent additives, a combination comprising at least one water-repellent additive and at least one additive other than a water-repellent additive) that comprise both one or more water-repellent functional groups (e.g., alkyl groups comprising greater than or equal to three carbon atoms, alkenyl groups comprising greater than or equal to three carbon atoms, alkynyl groups comprising greater than or equal to three carbon atoms) and one or more polar functional groups, the relative amounts of the water-repellent functional groups and the polar functional groups may generally be selected as desired. In some embodiments, a ratio of the number of water-repellent functional groups to the number of polar functional groups is greater than or equal to 0.1, greater than or equal to 0.15, greater than or equal to 0.2, greater than or equal to 0.25, greater than or equal to 0.33, greater than or equal to 0.5, greater than or equal to 0.75, greater than or equal to 1, greater than or equal to 1.5, greater than or equal to 2, greater than or equal to 2.5, greater than or equal to 3, greater than or equal to 4, greater than or equal to 5, or greater than or equal to 7.5. In some embodiments, a ratio of the number of water-repellent functional groups to the number of polar functional groups is less than or equal to 10, less than or equal to 7.5, less than or equal to 5, less than or equal to 4, less than or equal to 3, less than or equal to 2.5, less than or equal to 2, less than or equal to 1.5, less than or equal to 1, less than or equal to 0.75, less than or equal to 0.5, less than or equal to 0.33, less than or equal to 0.25, less than or equal to 0.2, or less than or equal to 0.15. Combinations of the above-referenced ranges are also possible (e.g., greater than or equal to 0.1 and less than or equal to 10, greater than or equal to 0.2 and less than or equal to 5, or greater than or equal to 0.33 and less than or equal to 3). Other ranges are also possible.

In some embodiments, a single water-repellent additive present in a filter media (that may lack other water-repellent additives or that may further comprise other water-repellent additives) has a ratio of the number of water-repellent functional groups to the number of polar functional groups in one or more of the above-referenced ranges. In some embodiments, the ratio of the number of water-repellent functional groups to the number of polar functional groups in the filter media as a whole is in one or more of the above-referenced ranges.

When a filter media comprises a polymeric water repellent additive that comprises both one or more repeat units comprising a water-repellent functional group (e.g., an alkyl group comprising greater than or equal to three carbon atoms, an alkenyl group comprising greater than or equal to three carbon atoms, an alkynyl group comprising greater than or equal to three carbon atoms) and one or more repeat units comprising a polar functional group, the relative amounts of the repeat units comprising the water-repellent functional groups and the repeat units comprising the polar functional groups may generally be selected as desired. In some embodiments, a ratio of the number of repeat units comprising the water-repellent functional groups to the number of repeat units comprising the polar functional groups is greater than or equal to 0.1, greater than or equal to 0.15, greater than or equal to 0.2, greater than or equal to 0.25, greater than or equal to 0.33, greater than or equal to 0.5, greater than or equal to 0.75, greater than or equal to 1, greater than or equal to 1.5, greater than or equal to 2, greater than or equal to 2.5, greater than or equal to 3, greater than or equal to 4, greater than or equal to 5, or greater than or equal to 7.5. In some embodiments, a ratio of the number of the repeat units comprising the water-repellent functional groups to the number of repeat units comprising the polar functional groups is less than or equal to 10, less than or equal to 7.5, less than or equal to 5, less than or equal to 4, less than or equal to 3, less than or equal to 2.5, less than or equal to 2, less than or equal to 1.5, less than or equal to 1, less than or equal to 0.75, less than or equal to 0.5, less than or equal to 0.33, less than or equal to 0.25, less than or equal to 0.2, or less than or equal to 0.15. Combinations of the above-referenced ranges are also possible (e.g., greater than or equal to 0.1 and less than or equal to 10, greater than or equal to 0.2 and less than or equal to 5, or greater than or equal to 0.33 and less than or equal to 3). Other ranges are also possible. When a repeat unit comprises both a water-repellent functional group and a polar functional group, it is considered to contribute to the number of both types of functional groups in the above-referenced ratios.

In some embodiments, a water-repellent additive (e.g., a water-repellent additive comprising a water-repellent functional group, a water-repellent additive having a structure described elsewhere herein and/or as shown in Structures 1-9) is a reaction product of one or more precursors. It is of course also possible for water-repellent additives described herein to not be reaction products obtained from precursors and/or to be provided directly to the filter media in their final form. When occurring, the reaction from which the water-repellent additive is formed may occur prior to and/or during filter media fabrication. As an example, in some embodiments, the reaction may occur during a step in which a layer in which the water-repellent additive is positioned is formed (e.g., a wet laying step). As another example, in some embodiments, the reaction may occur during a step after which the precursor(s) have been introduced to a layer present in the filter media (e.g., a drying step, a curing step, a post curing step).

In some embodiments, a reaction in which a water-repellent additive is formed comprises reacting two or more precursors with each other that both contribute one or more functional groups to the reaction product (e.g., in an addition and/or polymerization reaction), reacting one or more precursors contributing functional groups the reaction product with one or more precursors not contributing functional groups to the reaction product (e.g., in a reaction catalyzed by the one or more precursors not contributing functional groups to the reaction product), and/or reacting one or more precursors with one or more components of a layer in which the water-repellent additive is to be present in and/or disposed on (e.g., a grafting reaction). Non-limiting examples of suitable types of reactions that may occur include hydrolysis reactions and condensation reactions.

When a water-repellent additive is a reaction product of one or more precursors, the precursor(s) contributing functional groups to the reaction product may comprise one or more functional groups that are configured to and/or are capable of undergoing the relevant reaction. As an example, precursors contributing functional groups to the reaction product and configured to undergo a hydrolysis reaction may comprise one or more hydrolysable functional groups. Non-limiting examples of suitable hydrolysable functional groups include oxygenated functional groups (e.g., alcohol functional groups, methoxy functional groups, ethoxy functional groups, propoxy functional groups, butoxy functional groups, longer chain oxygenated functional groups) and halogenated functional groups (e.g., fluorine, chlorine, bromine). Functional groups configured to and/or capable of undergoing a reaction may be bonded to a silicon or metal atom prior to undergoing the relevant reaction. This silicon or metal atom may be a silicon or metal atom to which a water-repellent functional group is bonded and/or a silicon or metal atom to which a polar functional group is bonded. During and/or after the reaction, the functional groups configured to undergo the reaction may be partially or fully removed from the precursors, the water-repellent additive, and/or the filter media. Non-limiting examples of suitable precursors comprising silicon and/or metal atoms include silanes, titanates, zirconates, and aluminates.

Without wishing to be bound by any particular theory, it is believed that the number of hydrolysable functional groups present in a precursor may affect the structure of the reaction product that it reacts to form. Precursors comprising one hydrolysable functional group may, upon hydrolysis of the hydrolysable functional group, react with and/or be configured to react with one other reactive species (e.g., another precursor comprising one or more hydrolysable functional groups, a portion of a layer in the filter media) and so may react to form small molecules. Precursors comprising two hydrolysable functional groups may, upon hydrolysis of the functional groups, react with and/or be configured to react with two other reactive species (e.g., another precursor comprising one or more hydrolysable functional groups, a portion of a layer in the filter media) and so may react to form polymers, oligomers, or other linear molecules. Precursors comprising three or more hydrolysable functional groups may, upon hydrolysis of the functional groups, react to form branched reaction products and/or covalent networks. When a combination of precursors is employed that comprises precursors having different amounts of hydrolysable functional groups from each other, combinations of the above-described reaction products may form and/or reaction products having characteristics of two or more of the above-described reaction products may form.

It is also possible for at least a portion of one or more precursors contributing functional groups to the reaction product to a water-repellent additive to comprise a water-repellent functional group (e.g., an alkyl group comprising greater than or equal to three carbon atoms, an alkenyl group comprising greater than or equal to three carbon atoms, an alkynyl group comprising greater than or equal to three carbon atoms) and/or for at least a portion one or more precursors to a water-repellent additive to comprise a polar functional group. When both types of functional groups are present, a single precursor contributing functional groups to the reaction product may be provided that comprises them both and/or at least one precursor contributing functional groups to the reaction product may be provided that comprises one of these types of functional groups but not the other.

As described above, in some embodiments, a reaction resulting in a water-repellent additive may be between at least one precursor contributing functional groups to the water-repellent additive and at least one precursor not contributing functional groups to the water-repellent additive. For instance, the reaction may comprise catalyzing the reaction of the precursor(s) contributing functional groups to the water-repellent additive by exposing them to the precursor(s) not contributing functional groups to the water-repellent additive. One non-limiting example of a class of precursors having the latter property is ammonium salts, one non-limiting example of which is ammonium chloride.

As described elsewhere herein, some filter media may comprise a resin. Some suitable resins may also be water-repellent additives as described above, and some resins may not be water-repellent additives as described above. In some embodiments, a resin may be water-repellent but not comprise a water-repellent functional group as described above. It is also possible for a resin to be water-repellent and comprise a water-repellent functional group. Further details regarding some suitable resins are provided below.

When present, a resin may make up a variety of suitable amounts of a filter media in which it is positioned. In some embodiments, a resin makes up greater than or equal to 0 wt %, greater than or equal to 0.1 wt %, greater than or equal to 0.2 wt %, greater than or equal to 0.5 wt %, greater than or equal to 0.75 wt %, greater than or equal to 1 wt %, greater than or equal to 2 wt %, greater than or equal to 5 wt %, greater than or equal to 7.5 wt %, greater than or equal to 10 wt %, greater than or equal to 12.5 wt %, greater than or equal to 15 wt %, greater than or equal to 20 wt %, greater than or equal to 25 wt %, greater than or equal to 30 wt %, greater than or equal to 35 wt %, greater than or equal to 40 wt %, or greater than or equal to 45 wt % of the filter media. In some embodiments, a resin makes up less than or equal to 50 wt %, less than or equal to 45 wt %, less than or equal to 40 wt %, less than or equal to 35 wt %, less than or equal to 30 wt %, less than or equal to 25 wt %, less than or equal to 20 wt %, less than or equal to 15 wt %, less than or equal to 12.5 wt %, less than or equal to 10 wt %, less than or equal to 7.5 wt %, less than or equal to 5 wt %, less than or equal to 2 wt %, less than or equal to 1 wt %, less than or equal to 0.75 wt %, less than or equal to 0.5 wt %, less than or equal to 0.2 wt %, or less than or equal to 0.1 wt % of the filter media. Combinations of the above-referenced ranges are also possible (e.g., greater than or equal to 0 wt % and less than or equal to 50 wt %, greater than or equal to 0 wt % and less than or equal to 35 wt %, or greater than or equal to 1 wt % and less than or equal to 35 wt %). Other ranges are also possible. Additionally, in some embodiments, a filter media includes identically 0 wt % resin.

When a filter media comprises two or more resins, each resin may independently make up an amount of the filter media in one or more of the ranges described above. In some embodiments, the total resin content of the filter media is in one or more of the ranges described above.

The filter media described herein may comprise a variety of suitable resins. Non-limiting examples of such resins include latexes, acrylic polymers, epoxies, phenolic polymers, silicones, poly(esters), poly(amide)s, poly(imide)s, poly(urethane)s, poly(urea)s, poly(aramid)s, and copolymers of the foregoing. Non-limiting examples of suitable copolymers include dipolymers, terpolymers, and quaterpolymers. Additionally, the arrangement of the repeat units within a resin that is a copolymer may generally be selected as desired. To provide non-limiting examples, suitable resins may include random copolymers, alternating copolymers, periodic copolymers, statistical copolymers, block copolymers, blocky copolymers, stereoblock copolymers, tapered copolymers, and/or graft copolymers. It is also possible for a filter to comprise two or more different resins.

In some embodiments, a filter media comprises a resin that is a fluorinated resin. The fluorinated resin may be provided on its own, in combination with another fluorinated resin, and/or in combination with a non-fluorinated resin. The fluorinated resin may comprise a fluorinated repeat unit. For instance, in some embodiments, a fluorinated resin is one of the types of resins described in the preceding paragraph and comprises a fluorinated repeat unit. Further non-limiting examples of suitable repeat units include polymerized vinylidene difluoride repeat units, polymerized tetrafluoroethylene repeat units, polymerized hexafluoropropylene repeat units, polymerized vinyl fluoride repeat units, polymerized perfluorocycloalkene repeat units, polymerized chlorotrifluoroethylene repeat units, polymerized perfluoropropylvinylether repeat units, and polymerized perfluoromethylvinylether repeat units. In some embodiments, a filter media comprises a fluorinated resin that is a homopolymer, such as poly(tetrafluoroethylene) and/or poly(vinylidene difluoride). In some embodiments, the fluorinated repeat unit lacks a fluorinated side chain. In other words, some fluorinated resins may comprise fluorine atoms that are directly bonded to the backbone and lack fluorine atoms that are bonded to any side chains that are present. Other fluorinated resins may comprise fluorinated side chains.

When present, the fluorinated repeat unit may be the only repeat unit present in a fluorinated resin (in other words, the fluorinated resin may be a homopolymer) or the fluorinated repeat unit may be copolymerized with one or more additional non-fluorinated repeat units (in other words, the fluorinated resin may be a copolymer). Non-limiting examples of suitable types of non-fluorinated repeat units that may be copolymerized with fluorinated repeat units include polymerized non-fluorinated epoxy repeat units, polymerized non-fluorinated urethane repeat units, polymerized non-fluorinated ester repeat units, and polymerized non-fluorinated acrylic repeat units. In some embodiments, a fluorinated resin is a poly(vinylidene difluoride)-acrylic copolymer (i.e., a copolymer comprising vinylidene difluoride repeat units and non-fluorinated acrylic repeat units).

When a filter media comprises a fluorinated resin (e.g., a poly(vinylidene difluoride)-acrylic copolymer), the fluorinated repeat units may make up a variety of suitable amounts of the resin. In some embodiments, fluorinated repeat units make up greater than or equal to 30 wt %, greater than or equal to 35 wt %, greater than or equal to 40 wt %, greater than or equal to 45 wt %, greater than or equal to 50 wt %, greater than or equal to 55 wt %, greater than or equal to 60 wt %, greater than or equal to 65 wt %, greater than or equal to 70 wt %, greater than or equal to 75 wt %, greater than or equal to 80 wt %, greater than or equal to 85 wt %, greater than or equal to 90 wt %, or greater than or equal to 95 wt % of the resin. In some embodiments, fluorinated repeat units make up less than or equal to 100 wt %, less than or equal to 95 wt %, less than or equal to 90 wt %, less than or equal to 85 wt %, less than or equal to 80 wt %, less than or equal to 75 wt %, less than or equal to 70 wt %, less than or equal to 65 wt %, less than or equal to 60 wt %, less than or equal to 55 wt %, less than or equal to 50 wt %, less than or equal to 45 wt %, less than or equal to 40 wt %, or less than or equal to 35 wt % of the resin. Combinations of the above-referenced ranges are also possible (e.g., greater than or equal to 30 wt % and less than or equal to 100 wt %, or greater than or equal to 50 wt % and less than or equal to 100 wt %). Other ranges are also possible. In some embodiments, the fluorinated repeat units make up identically 100 wt % of the resin.

In some embodiments, a filter media comprises one resin having an amount of fluorinated repeat units in one or more of the above-referenced ranges and may further comprise other resins (which may each independently comprise fluorinated repeat units or lack fluorinated repeat units). In some embodiments, a filter media comprises two or more resins (at least one of which, but not necessarily all of which, comprise fluorinated repeat units), and all of the resins in the filter media together have an amount of fluorinated repeat units in one or more of the above-referenced ranges.

It is also possible for a resin to lack fluorinated repeat units and/or to be unfluorinated.

As described elsewhere herein, in some embodiments, a filter media comprises a non-woven fiber web. The non-woven fiber web may be a layer in which one or more of the above-described additives and/or resins are positioned and/or on which one or more of the above-described additives and/or resins are disposed (e.g., in the form of a coating). The non-woven fiber web may serve as the main filter layer. Non-limiting examples of non-woven fiber webs suitable for this purpose include wet laid fiber webs, non-wet laid fiber webs, and combinations of the two. Further details regarding some non-woven fiber webs suitable for use as main filter layers are provided below.

In some embodiments, a non-woven fiber web comprises glass fibers. The glass fibers may make up a variety of suitable amounts of the non-woven fiber web. In some embodiments, glass fibers make up greater than or equal to 0 wt %, greater than or equal to 1 wt %, greater than or equal to 2 wt %, greater than or equal to 5 wt %, greater than or equal to 7.5 wt %, greater than or equal to 10 wt %, greater than or equal to 15 wt %, greater than or equal to 20 wt %, greater than or equal to 25 wt %, greater than or equal to 30 wt %, greater than or equal to 40 wt %, greater than or equal to 50 wt %, greater than or equal to 60 wt %, or greater than or equal to 80 wt % of the fibers in the non-woven fiber web. In some embodiments, glass fibers make up less than or equal to 100 wt %, less than or equal to 80 wt %, less than or equal to 60 wt %, less than or equal to 50 wt %, less than or equal to 40 wt %, less than or equal to 30 wt %, less than or equal to 25 wt %, less than or equal to 20 wt %, less than or equal to 15 wt %, less than or equal to 10 wt %, less than or equal to 7.5 wt %, less than or equal to 5 wt %, less than or equal to 2 wt %, or less than or equal to 1 wt % of the fibers in the non-woven fiber web. Combinations of the above-referenced ranges are also possible (e.g., greater than or equal to 0 wt % and less than or equal to 100 wt %). Other ranges are also possible. In some embodiments, glass fibers make up exactly 0 wt % of the fibers in a non-woven fiber web. In some embodiments, glass fibers make up exactly 100 wt % of the fibers in a non-woven fiber web.

When a filter media comprises two or more non-woven fiber webs, each non-woven fiber web may independently have an amount of glass fibers in one or more of the ranges described above.

In some embodiments, a non-woven fiber web comprises microglass fibers. The microglass fibers may comprise microglass fibers drawn from bushing tips and further subjected to flame blowing or rotary spinning processes. In some cases, microglass fibers may be made using a remelting process. The microglass fibers may be microglass fibers for which alkali metal oxides (e.g., sodium oxides, magnesium oxides) make up 10-20 wt % of the fibers. Such fibers may have relatively lower melting and processing temperatures. Non-limiting examples of microglass fibers include B glass fibers, E glass fibers, S glass fibers, M glass fibers according to Man Made Vitreous Fibers by Nomenclature Committee of TIMA Inc. March 1993, Page 45, C glass fibers (e.g., Lauscha C glass fibers, JM 253 C glass fibers), and non-persistent glass fibers (e.g., fibers that are configured to dissolve completely in the fluid present in human lungs in less than or equal to 40 days, such as Johns Manville 481 fibers). It should be understood that microglass fibers present in a non-woven fiber web may comprise one or more of the types of microglass fibers described herein.

When present, the microglass fibers may make up a variety of suitable amounts of a non-woven fiber web. In some embodiments, the microglass fibers make up greater than or equal to 1 wt %, greater than or equal to greater than or equal to 2 wt %, greater than or equal to 5 wt %, greater than or equal to 7.5 wt %, greater than or equal to 10 wt %, greater than or equal to 15 wt %, greater than or equal to 20 wt %, greater than or equal to 25 wt %, greater than or equal to 30 wt %, greater than or equal to 40 wt %, greater than or equal to 50 wt %, greater than or equal to 60 wt %, or greater than or equal to 80 wt % of the fibers in the non-woven fiber web. In some embodiments, microglass fibers make up less than or equal to 100 wt %, less than or equal to 80 wt %, less than or equal to 60 wt %, less than or equal to 50 wt %, less than or equal to 40 wt %, less than or equal to 30 wt %, less than or equal to 25 wt %, less than or equal to 20 wt %, less than or equal to 15 wt %, less than or equal to 10 wt %, less than or equal to 7.5 wt %, less than or equal to 5 wt %, or less than or equal to 2 wt % of the fibers in the non-woven fiber web. Combinations of the above-referenced ranges are also possible (e.g., greater than or equal to 1 wt % and less than or equal to 100 wt %). Other ranges are also possible. In some embodiments, glass fibers make up exactly 100 wt % of the fibers in a non-woven fiber web.

When a non-woven fiber web comprises two or more types of microglass fibers, each type of microglass fiber may independently make up an amount of the non-woven fiber web in one or more of the ranges described above. Additionally, in some embodiments, a total amount of microglass fibers in a non-woven fiber web may be in one or more of the ranges described above. Similarly, when a filter media comprises two or more non-woven fiber webs, each type of microglass fiber may independently make up an amount of each non-woven fiber web in one or more of the ranges described above and/or the total amount of microglass fibers in each non-woven fiber web may independently be in one or more of the ranges described above.

When present, the microglass fibers may have a variety of suitable average diameters. In some embodiments, the average diameter of the microglass fibers in a non-woven fiber web is greater than or equal to 0.1 micron, greater than or equal to 0.15 microns, greater than or equal to 0.2 microns, greater than or equal to 0.25 microns, greater than or equal to 0.3 microns, greater than or equal to 0.35 microns, greater than or equal to 0.4 microns, greater than or equal to 0.45 microns, greater than or equal to 0.5 microns, greater than or equal to 0.55 microns, greater than or equal to 0.6 microns, greater than or equal to 0.65 microns, greater than or equal to 0.7 microns, greater than or equal to 0.75 microns, greater than or equal to 0.8 microns, greater than or equal to 0.85 microns, greater than or equal to 0.9 microns, greater than or equal to 0.95 microns, greater than or equal to 1 micron, greater than or equal to 1.25 microns, greater than or equal to 1.5 microns, greater than or equal to 2 microns, greater than or equal to 2.5 microns, greater than or equal to 3 microns, greater than or equal to 5 microns, or greater than or equal to 7.5 microns. In some embodiments, the average diameter of the microglass fibers in a non-woven fiber web is less than or equal to 10 microns, less than or equal to 7.5 microns, less than or equal to 5 microns, less than or equal to 3 microns, less than or equal to 2.5 microns, less than or equal to 2 microns, less than or equal to 1.5 microns, less than or equal to 1.25 microns, less than or equal to 1 micron, less than or equal to 0.95 microns, less than or equal to 0.9 microns, less than or equal to 0.85 microns, less than or equal to 0.8 microns, less than or equal to 0.75 microns, less than or equal to 0.7 microns, less than or equal to 0.65 microns, less than or equal to 0.6 microns, less than or equal to 0.55 microns, less than or equal to 0.5 microns, less than or equal to 0.45 microns, less than or equal to 0.4 microns, less than or equal to 0.35 microns, less than or equal to 0.3 microns, less than or equal to 0.25 microns, less than or equal to 0.2 microns, or less than or equal to 0.15 microns. Combinations of the above-referenced ranges are also possible (e.g., greater than or equal to 0.1 micron and less than or equal to 10 microns, greater than or equal to 0.2 microns and less than or equal to 0.55 microns, greater than or equal to 0.2 microns and less than or equal to 0.4 microns, greater than or equal to 0.4 microns and less than or equal to 1 micron, greater than or equal to 0.5 microns and less than or equal to 1 micron, greater than or equal to 2 microns and less than or equal to 10 microns, or greater than or equal to 2.5 microns and less than or equal to 10 microns). Other ranges are also possible.

When a non-woven fiber web comprises two or more types of microglass fibers, each type of microglass fiber may have an average diameter in one or more of the ranges described above. Additionally, in some embodiments, all of the microglass fibers in a non-woven fiber web together have an average diameter in one or more of the ranges described above. Similarly, when a filter media comprises two or more non-woven fiber webs, each non-woven fiber web may independently comprise microglass fibers (of one or more types independently, of all types together) having an average diameter in one or more of the ranges described above.

In some embodiments, a non-woven fiber web comprises a particular type of microglass fibers in a particularly advantageous amount. As another example, in some embodiments, a non-woven fiber web comprises relatively fine microglass fibers (e.g., having an average diameter of between 0.2 microns and 0.55 microns and/or between 0.2 microns and 0.45 microns) in an amount of greater than or equal to 1.5 wt %, greater than or equal to 2 wt %, greater than or equal to 5 wt %, greater than or equal to 7.5 wt %, greater than or equal to 10 wt %, greater than or equal to 15 wt %, greater than or equal to 20 wt %, greater than or equal to 30 wt %, greater than or equal to 40 wt %, greater than or equal to 50 wt %, greater than or equal to 60 wt %, greater than or equal to 70 wt %, greater than or equal to 80 wt %, or greater than or equal to 90 wt % of the fibers in the non-woven fiber web. In some embodiments, a non-woven fiber web comprises relatively fine microglass fibers in an amount of less than or equal to 100 wt %, less than or equal to 90 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, less than or equal to 15 wt %, less than or equal to 10 wt %, less than or equal to 7.5 wt %, less than or equal to 5 wt %, or less than or equal to 2 wt % of the fibers in a non-woven fiber web. Combinations of the above-referenced ranges are also possible (e.g., greater than or equal to 1.5 wt % and less than or equal to 100 wt %). Other ranges are also possible. In some embodiments, relatively fine microglass fibers make up exactly 100 wt % of the fibers in a non-woven fiber web.

When a filter media comprises two or more non-woven fiber webs, each non-woven fiber web may independently comprise an amount of microglass fibers having an average diameter of between 0.2 microns and 0.45 microns in one or more of the ranges described above.

As another example, in some embodiments, a non-woven fiber web comprises microglass fibers having moderate diameters (e.g., having an average diameter of between 0.4 microns and 1 micron and/or having an average diameter of between 0.5 microns and 1 micron) in an amount of greater than or equal to 1.5 wt %, greater than or equal to 2 wt %, greater than or equal to 5 wt %, greater than or equal to 7.5 wt %, greater than or equal to 10 wt %, greater than or equal to 15 wt %, greater than or equal to 20 wt %, greater than or equal to 30 wt %, greater than or equal to 40 wt %, greater than or equal to 50 wt %, greater than or equal to 60 wt %, greater than or equal to 70 wt %, greater than or equal to 80 wt %, or greater than or equal to 90 wt % of the fibers in the non-woven fiber web. In some embodiments, a non-woven fiber web comprises microglass fibers having moderate diameters in an amount of less than or equal to 100 wt %, less than or equal to 90 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, less than or equal to 15 wt %, less than or equal to 10 wt %, less than or equal to 7.5 wt %, less than or equal to 5 wt %, or less than or equal to 2 wt % of the fibers in a non-woven fiber web. Combinations of the above-referenced ranges are also possible (e.g., greater than or equal to 1.5 wt % and less than or equal to 100 wt %). Other ranges are also possible. In some embodiments, microglass fibers having moderate diameters make up exactly 100 wt % of the fibers in a non-woven fiber web.

When a filter media comprises two or more non-woven fiber webs, each non-woven fiber web may independently comprise an amount of microglass fibers having moderate diameters in one or more of the ranges described above.

As a third example, in some embodiments, a non-woven fiber web comprises relatively coarse glass fibers (e.g., microglass fibers having an average diameter of between 2 and 10 microns and/or between 2.5 and 10 microns) in an amount of greater than or equal to 0 wt %, greater than or equal to 1 wt %, greater than or equal to 2 wt %, greater than or equal to 5 wt %, greater than or equal to 7.5 wt %, greater than or equal to 10 wt %, greater than or equal to 15 wt %, greater than or equal to 20 wt %, greater than or equal to 25 wt %, greater than or equal to 30 wt %, greater than or equal to 40 wt %, greater than or equal to 50 wt %, greater than or equal to 60 wt %, or greater than or equal to 80 wt % of the fibers in a non-woven fiber web. In some embodiments, a non-woven fiber web comprises relatively coarse glass fibers in an amount of less than or equal to 95 wt %, less than or equal to 80 wt %, less than or equal to 60 wt %, less than or equal to 50 wt %, less than or equal to 40 wt %, less than or equal to 30 wt %, less than or equal to 25 wt %, less than or equal to 20 wt %, less than or equal to 15 wt %, less than or equal to 10 wt %, less than or equal to 7.5 wt %, less than or equal to 5 wt %, less than or equal to 2 wt %, or less than or equal to 1 wt % of the fibers in a non-woven fiber web. Combinations of the above-referenced ranges are also possible (e.g., greater than or equal to 0 wt % and less than or equal to 95 wt %). Other ranges are also possible. In some embodiments, relatively coarse glass fibers make up exactly 0 wt % of the fibers in a non-woven fiber web.

When a filter media comprises two or more non-woven fiber webs, each non-woven fiber web may independently comprise an amount of relatively coarse microglass fibers in one or more of the ranges described above.

In some embodiments, a filter media may comprise two, three, or more types of microglass fibers (e.g., two or all of the following: relatively fine microglass fibers, microglass fibers having a moderate diameter, and relatively coarse microglass fibers). In embodiments comprising two or more types of microglass fibers (e.g., both relatively fine microglass fibers and microglass fibers having moderate diameters, both relatively fine microglass fibers and relatively coarse microglass fibers, both microglass fibers having a moderate diameter and relatively coarse microglass fibers, all three of the foregoing types of microglass fibers), microglass fibers falling into a category described by a relatively larger diameter may have an average diameter larger than that of the microglass fibers falling into the category described by a relatively small diameter. The differences in fiber diameter between populations of microglass fibers present may be sufficiently large such that the two or more populations of fibers could be readily distinguished by microscopy.

In some embodiments, a non-woven fiber web comprises chopped strand glass fibers. The chopped strand glass fibers may comprise chopped strand glass fibers which were produced by drawing a melt of glass from bushing tips into continuous fibers and then cutting the continuous fibers into short fibers. In some embodiments, a non-woven fiber web comprises chopped strand glass fibers for which alkali metal oxides (e.g., sodium oxides, magnesium oxides) make up a relatively low amount of the fibers. It is also possible for a non-woven fiber web to comprise chopped strand glass fibers that include relatively large amounts of calcium oxide and/or alumina (Al₂O₃). In some embodiments, a non-woven fiber web comprises S-glass fibers, which include approximately 10 wt % magnesium oxide. It should be understood that chopped strand glass fibers present in a non-woven fiber web may comprise one or more of the types of chopped strand glass fibers described herein.

When present, chopped strand glass fibers may make up a variety of suitable amounts of a non-woven fiber web. In some embodiments, chopped strand glass fibers make up greater than or equal to 0 wt %, greater than or equal to 1 wt %, greater than or equal to 2 wt %, greater than or equal to 5 wt %, greater than or equal to 7.5 wt %, greater than or equal to 10 wt %, greater than or equal to 15 wt %, greater than or equal to 20 wt %, greater than or equal to 25 wt %, greater than or equal to 30 wt %, greater than or equal to 40 wt %, greater than or equal to 50 wt %, greater than or equal to 60 wt %, or greater than or equal to 70 wt % of the fibers in a non-woven fiber web. In some embodiments, chopped strand glass fibers make up less than or equal to 80 wt %, less than or equal to 70 wt %, less than or equal to 60 wt %, less than or equal to 50 wt %, less than or equal to 40 wt %, less than or equal to 30 wt %, less than or equal to 25 wt %, less than or equal to 20 wt %, less than or equal to 15 wt %, less than or equal to 10 wt %, less than or equal to 7.5 wt %, less than or equal to 5 wt %, less than or equal to 2 wt %, or less than or equal to 1 wt % of the fibers in a non-woven fiber web. Combinations of the above-referenced ranges are also possible (e.g., greater than or equal to 0 wt % and less than or equal to 95 wt %). Other ranges are also possible. In some embodiments, chopped strand glass fibers make up exactly 0 wt % of the fibers in a non-woven fiber web.

When a non-woven fiber web comprises two or more types of chopped strand glass fibers, each type of chopped strand glass fiber may independently make up an amount of the non-woven fiber web in one or more of the ranges described above. Additionally, in some embodiments, a total amount of chopped strand glass fibers in a non-woven fiber web may be in one or more of the ranges described above. Similarly, when a filter media comprises two or more non-woven fiber webs, each type of chopped strand glass fiber may independently make up an amount of each non-woven fiber web in one or more of the ranges described above and/or the total amount of chopped strand glass fibers in each non-woven fiber web may independently be in one or more of the ranges described above.

When present, the chopped strand glass fibers may have a variety of suitable average diameters. In some embodiments, a non-woven fiber web comprises chopped strand glass fibers having an average diameter of greater than or equal to 5 microns, greater than or equal to 6 microns, greater than or equal to 6.5 microns, greater than or equal to 7.5 microns, greater than or equal to 10 microns, greater than or equal to 12.5 microns, greater than or equal to 15 microns, greater than or equal to 20 microns, greater than or equal to 25 microns, greater than or equal to 30 microns, greater than or equal to 35 microns, greater than or equal to 40 microns, or greater than or equal to 45 microns. In some embodiments, a non-woven fiber web comprises chopped strand glass fibers having an average diameter of less than or equal to 50 microns, less than or equal to 45 microns, less than or equal to 40 microns, less than or equal to 35 microns, less than or equal to 30 microns, less than or equal to 25 microns, less than or equal to 20 microns, less than or equal to 15 microns, less than or equal to 12.5 microns, less than or equal to 10 microns, less than or equal to 7.5 microns, less than or equal to 6.5 microns, or less than or equal to 6 microns. Combinations of the above-referenced ranges are also possible (e.g., greater than or equal to 5 microns and less than or equal to 50 microns). Other ranges are also possible.

When a non-woven fiber web comprises two or more types of chopped strand glass fibers, each type of chopped strand glass fiber may have an average diameter in one or more of the ranges described above. Additionally, in some embodiments, all of the chopped strand glass fibers in a non-woven fiber web together have an average diameter in one or more of the ranges described above. Similarly, when a filter media comprises two or more non-woven fiber webs, each non-woven fiber web may independently comprise chopped strand glass fibers (of one or more types independently, of all types together) having an average diameter in one or more of the ranges described above.

When present, the chopped strand glass fibers may have a variety of suitable average lengths. In some embodiments, a non-woven fiber web comprises chopped strand glass fibers having an average length of greater than or equal to 0.05 inches, greater than or equal to 0.075 inches, greater than or equal to 0.1 inch, greater than or equal to 0.2 inches, greater than or equal to 0.5 inches, greater than or equal to 0.75 inches, greater than or equal to 1 inch, greater than or equal to 1.25 inches, greater than or equal to 1.5 inches, greater than or equal to 2 inches, or greater than or equal to 2.5 inches. In some embodiments, a non-woven fiber web comprises chopped strand glass fibers having an average length of less than or equal to 3 inches, less than or equal to 2.5 inches, less than or equal to 2 inches, less than or equal to 1.5 inches, less than or equal to 1.25 inches, less than or equal to 1 inch, less than or equal to 0.75 inches, less than or equal to 0.5 inches, less than or equal to 0.2 inches, less than or equal to 0.1 inch, or less than or equal to 0.075 inches. Combinations of the above-referenced ranges are also possible (e.g., greater than or equal to 0.05 inches and less than or equal to 3 inches). Other ranges are also possible.

When a non-woven fiber web comprises two or more types of chopped strand glass fibers, each type of chopped strand glass fiber may have an average length in one or more of the ranges described above. Additionally, in some embodiments, all of the chopped strand glass fibers in a non-woven fiber web together have an average length in one or more of the ranges described above. Similarly, when a filter media comprises two or more non-woven fiber webs, each non-woven fiber web may independently comprise chopped strand glass fibers (of one or more types independently, of all types together) having an average length in one or more of the ranges described above.

In some embodiments, a non-woven fiber web comprises natural fibers. When present, the natural fibers may make up a variety of suitable amounts of the non-woven fiber web. In some embodiments, natural fibers make up greater than or equal to 0 wt %, greater than or equal to 1 wt %, greater than or equal to 2 wt %, greater than or equal to 5 wt %, greater than or equal to 7.5 wt %, greater than or equal to 10 wt %, greater than or equal to 15 wt %, greater than or equal to 20 wt %, greater than or equal to 25 wt %, greater than or equal to 30 wt %, greater than or equal to 40 wt %, greater than or equal to 50 wt %, greater than or equal to 60 wt %, or greater than or equal to 80 wt % of the fibers in a non-woven fiber web. In some embodiments, natural fibers make up less than or equal to 100 wt %, less than or equal to 80 wt %, less than or equal to 60 wt %, less than or equal to 50 wt %, less than or equal to 40 wt %, less than or equal to 30 wt %, less than or equal to 25 wt %, less than or equal to 20 wt %, less than or equal to 15 wt %, less than or equal to 10 wt %, less than or equal to 7.5 wt %, less than or equal to 5 wt %, less than or equal to 2 wt %, or less than or equal to 1 wt % of the fibers in a non-woven fiber web. Combinations of the above-referenced ranges are also possible (e.g., greater than or equal to 0 wt % and less than or equal to 100 wt %). Other ranges are also possible. In some embodiments, natural fibers make up exactly 0 wt % of the fibers in a non-woven fiber web. In some embodiments, natural fibers make up exactly 100 wt % of the fibers in a non-woven fiber web.

When a non-woven fiber web comprises two or more types of natural fibers, each type of natural fiber may independently make up an amount of the non-woven fiber web in one or more of the ranges described above. Additionally, in some embodiments, a total amount of natural fibers in a non-woven fiber web may be in one or more of the ranges described above. Similarly, when a filter media comprises two or more non-woven fiber webs, each type of natural fiber may independently make up an amount of each non-woven fiber web in one or more of the ranges described above and/or the total amount of natural fibers in each non-woven fiber web may independently be in one or more of the ranges described above.

One example of a natural fiber is natural cellulose fibers. When a fiber web comprises natural cellulose fibers, the natural cellulose fibers may be wood (e.g., cedar) fibers, such as softwood fibers and/or hardwood fibers. Other examples of natural cellulose fibers are also possible (e.g., nano-cellulose fibers, such as nanofibrillated fibers and/or fibrous cellulose nanocrystals; microfibrillated cellulose). It is also possible for a fiber web to comprise wool.

Exemplary softwood fibers include fibers obtained from mercerized southern pine (“mercerized southern pine fibers or HPZ fibers”), northern bleached softwood kraft (e.g., fibers obtained from Robur Flash (“Robur Flash fibers”)), southern bleached softwood kraft (e.g., fibers obtained from Brunswick pine (“Brunswick pine fibers”)), and/or chemically treated mechanical pulps (“CTMP fibers”). For example, HPZ fibers can be obtained from Buckeye Technologies, Inc., Memphis, Tenn.; Robur Flash fibers can be obtained from Rottneros AB, Stockholm, Sweden; and Brunswick pine fibers can be obtained from Georgia-Pacific, Atlanta, Ga.

Exemplary hardwood fibers include fibers obtained from Eucalyptus (“Eucalyptus fibers”). Eucalyptus fibers are commercially available from, e.g., (1) Suzano Group, Suzano, Brazil (“Suzano fibers”), (2) Group Portucel Soporcel, Cacia, Portugal (“Cacia fibers”), (3) Tembec, Inc., Temiscaming, QC, Canada (“Tarascon fibers”), (4) Kartonimex Intercell, Duesseldorf, Germany, (“Acacia fibers”), (5) Mead-Westvaco, Stamford, Conn. (“Westvaco fibers”), and (6) Georgia-Pacific, Atlanta, Ga. (“Leaf River fibers”).

When present, the natural fibers may have a variety of suitable average diameters. In some embodiments, a non-woven fiber web comprises natural fibers having an average diameter of greater than or equal to 1 micron, greater than or equal to 2 microns, greater than or equal to 5 microns, greater than or equal to 7.5 microns, greater than or equal to 10 microns, greater than or equal to 15 microns, greater than or equal to 20 microns, greater than or equal to 30 microns, or greater than or equal to 40 microns. In some embodiments, a non-woven fiber web comprises natural fibers having an average diameter of less than or equal to 50 microns, less than or equal to 40 microns, less than or equal to 30 microns, less than or equal to 20 microns, less than or equal to 15 microns, less than or equal to 10 microns, less than or equal to 7.5 microns, less than or equal to 5 microns, or less than or equal to 2 microns. Combinations of the above-referenced ranges are also possible (e.g., greater than or equal to 1 micron and less than or equal to 50 microns). Other ranges are also possible.

When a non-woven fiber web comprises two or more types of natural fibers, each type of natural fiber may have an average diameter in one or more of the ranges described above. Additionally, in some embodiments, all of the natural fibers in a non-woven fiber web together have an average diameter in one or more of the ranges described above. Similarly, when a filter media comprises two or more non-woven fiber webs, each non-woven fiber web may independently comprise natural fibers (of one or more types independently, of all types together) having an average diameter in one or more of the ranges described above.

In some embodiments, a non-woven fiber web comprises synthetic fibers. The synthetic fibers may make up a variety of suitable amounts of the non-woven fiber web. In some embodiments, synthetic fibers make up greater than or equal to 0 wt %, greater than or equal to 1 wt %, greater than or equal to 2 wt %, greater than or equal to 5 wt %, greater than or equal to 7.5 wt %, greater than or equal to 10 wt %, greater than or equal to 15 wt %, greater than or equal to 20 wt %, greater than or equal to 25 wt %, greater than or equal to 30 wt %, greater than or equal to 40 wt %, greater than or equal to 50 wt %, greater than or equal to 60 wt %, or greater than or equal to 80 wt % of the fibers in a non-woven fiber web. In some embodiments, synthetic fibers make up less than or equal to 100 wt %, less than or equal to 80 wt %, less than or equal to 60 wt %, less than or equal to 50 wt %, less than or equal to 40 wt %, less than or equal to 30 wt %, less than or equal to 25 wt %, less than or equal to 20 wt %, less than or equal to 15 wt %, less than or equal to 10 wt %, less than or equal to 7.5 wt %, less than or equal to 5 wt %, less than or equal to 2 wt %, or less than or equal to 1 wt % of the fibers in a non-woven fiber web. Combinations of the above-referenced ranges are also possible (e.g., greater than or equal to 0 wt % and less than or equal to 100 wt %). Other ranges are also possible. In some embodiments, synthetic fibers make up exactly 0 wt % of the fibers in a non-woven fiber web. In some embodiments, synthetic fibers make up exactly 100 wt % of the fibers in a non-woven fiber web.

When a non-woven fiber web comprises two or more types of synthetic fibers, each type of synthetic fiber may independently make up an amount of the non-woven fiber web in one or more of the ranges described above. Additionally, in some embodiments, a total amount of synthetic fibers in a non-woven fiber web may be in one or more of the ranges described above. Similarly, when a filter media comprises two or more non-woven fiber webs, each type of synthetic fiber may independently make up an amount of each non-woven fiber web in one or more of the ranges described above and/or the total amount of synthetic fibers in each non-woven fiber web may independently be in one or more of the ranges described above.

A variety of suitable types of synthetic fibers may be employed in the non-woven fiber webs described herein. In some embodiments, a non-woven fiber web comprises monocomponent synthetic fibers. Non-limiting examples of suitable polymers that may be included in synthetic fibers include: acrylics, poly(vinyl alcohol), poly(ester)s (e.g., poly(ethylene terephthalate)), poly(acrylonitrile), poly(olefin)s (e.g., poly(ethylene), poly(propylene)), poly(vinylidene difluoride), poly(ether sulfone), poly(vinyl chloride), poly(amide)s, poly(imide)s, aramids (e.g., meta-aramids, para-aramids), poly(etherimide), poly(ether ether ketone), liquid crystal polymers (e.g., poly(p-phenylene-2,6-benzobisoxazole; poly(ester)-based liquid crystal polymers, such as fibers produced by the polycondensation of 4-hydroxybenzoic acid and 6-hydroxynaphthalene-2-carboxylic acid), regenerated cellulose (e.g., lyocell, rayon), celluloid, cellulose acetate, carboxymethylcellulose copolymers of the foregoing, and blends of the foregoing.

When present, the synthetic fibers may have a variety of suitable average diameters. In some embodiments, a non-woven fiber web comprises synthetic fibers having an average diameter of greater than or equal to 0.01 micron, greater than or equal to 0.02 microns, greater than or equal to 0.05 microns, greater than or equal to 0.075 microns, greater than or equal to 0.1 micron, greater than or equal to 0.2 microns, greater than or equal to 0.5 microns, greater than or equal to 0.75 microns, greater than or equal to 1 micron, greater than or equal to 2 microns, greater than or equal to 5 microns, greater than or equal to 7.5 microns, greater than or equal to 10 microns, greater than or equal to 20 microns, greater than or equal to 50 microns, or greater than or equal to 75 microns. In some embodiments, a non-woven fiber web comprises synthetic fibers having an average diameter of less than or equal to 100 microns, less than or equal to 75 microns, less than or equal to 50 microns, less than or equal to 20 microns, less than or equal to 10 microns, less than or equal to 7.5 microns, less than or equal to 5 microns, less than or equal to 2 microns, less than or equal to 1 micron, less than or equal to 0.75 microns, less than or equal to 0.5 microns, less than or equal to 0.2 microns, less than or equal to 0.1 micron, less than or equal to 0.075 microns, less than or equal to 0.05 microns, or less than or equal to 0.02 microns. Combinations of the above-referenced ranges are also possible (e.g., greater than or equal to 0.01 micron and less than or equal to 100 microns). Other ranges are also possible.

When a non-woven fiber web comprises two or more types of synthetic fibers, each type of synthetic fiber may have an average diameter in one or more of the ranges described above. Additionally, in some embodiments, all of the synthetic fibers in a non-woven fiber web together have an average diameter in one or more of the ranges described above. Similarly, when a filter media comprises two or more non-woven fiber webs, each non-woven fiber web may independently comprise synthetic fibers (of one or more types independently, of all types together) having an average diameter in one or more of the ranges described above.

When present, synthetic fibers may comprise continuous fibers and/or non-continuous fibers. Continuous fibers may be made by a “continuous” fiber-forming process, such as a meltblown or a spunbond process, and typically have longer lengths than non-continuous fibers. Non-continuous fibers may be staple fibers that may be cut (e.g., from a filament) or formed as non-continuous discrete fibers to have a particular length or a range of lengths as described in more detail herein. In certain embodiments, a non-woven fiber web comprises continuous fibers that have an average length of greater than 5 inches.

When present, the synthetic fibers may have a variety of suitable average lengths. In some embodiments, a non-woven fiber web comprises synthetic fibers having an average length of greater than or equal to 0.01 inch, greater than or equal to 0.02 inches, greater than or equal to 0.05 inches, greater than or equal to 0.075 inches, greater than or equal to 0.1 inch, greater than or equal to 0.2 inches, greater than or equal to 0.5 inches, greater than or equal to 0.75 inches, greater than or equal to 1 inch, greater than or equal to 2 inches, greater than or equal to 5 inches, or greater than or equal to 7.5 inches. In some embodiments, a non-woven fiber web comprises synthetic fibers having an average length of less than or equal to 10 inches, less than or equal to 7.5 inches, less than or equal to 5 inches, less than or equal to 2 inches, less than or equal to 1 inch, less than or equal to 0.75 inches, less than or equal to 0.5 inches, less than or equal to 0.2 inches, less than or equal to 0.1 inch, less than or equal to 0.075 inches, less than or equal to 0.05 inches, or less than or equal to 0.02 inches. Combinations of the above-referenced ranges are also possible (e.g., greater than or equal to 0.01 inches and less than or equal to 10 inches). Other ranges are also possible.

When a non-woven fiber web comprises two or more types of synthetic fibers, each type of synthetic fiber may have an average length in one or more of the ranges described above. Additionally, in some embodiments, all of the synthetic fibers in a non-woven fiber web together have an average length in one or more of the ranges described above. Similarly, when a filter media comprises two or more non-woven fiber webs, each non-woven fiber web may independently comprise synthetic fibers (of one or more types independently, of all types together) having an average length in one or more of the ranges described above.

In some embodiments, a non-woven fiber web comprises binder fibers. The binder fibers may make up a variety of suitable amounts of the non-woven fiber web. In some embodiments, binder fibers make up greater than or equal to 0 wt %, greater than or equal to 1 wt %, greater than or equal to 2 wt %, greater than or equal to 5 wt %, greater than or equal to 7.5 wt %, greater than or equal to 10 wt %, greater than or equal to 15 wt %, greater than or equal to 20 wt %, greater than or equal to 25 wt %, greater than or equal to 30 wt %, greater than or equal to 40 wt %, greater than or equal to 50 wt %, greater than or equal to 60 wt %, or greater than or equal to 80 wt % of the fibers in a non-woven fiber web. In some embodiments, binder fibers make up less than or equal to 90 wt %, less than or equal to 80 wt %, less than or equal to 60 wt %, less than or equal to 50 wt %, less than or equal to 40 wt %, less than or equal to 30 wt %, less than or equal to 25 wt %, less than or equal to 20 wt %, less than or equal to 15 wt %, less than or equal to 10 wt %, less than or equal to 7.5 wt %, less than or equal to 5 wt %, less than or equal to 2 wt %, or less than or equal to 1 wt % of the fibers in a non-woven fiber web. Combinations of the above-referenced ranges are also possible (e.g., greater than or equal to 0 wt % and less than or equal to 90 wt %). Other ranges are also possible. In some embodiments, binder fibers make up exactly 0 wt % of the fibers in a non-woven fiber web.

A variety of suitable types of binder fibers may be employed in the non-woven fiber webs described herein. In some embodiments, the binder fibers comprise multicomponent fibers and/or monocomponent fibers. The multicomponent fibers may comprise bicomponent fibers (i.e., fibers including two components), and/or may comprise fibers comprising three or more components. Multicomponent fibers may have a variety of suitable structures. For instance, a non-woven fiber web may comprise one or more of the following types of multicomponent fibers: core/sheath fibers (e.g., concentric core/sheath fibers, non-concentric core-sheath fibers), segmented pie fibers, side-by-side fibers, tip-trilobal fibers, and “island in the sea” fibers. Core-sheath bicomponent fibers may comprise a sheath that has a lower melting temperature than that of the core. When heated (e.g., during a binding step), the sheath may melt prior to the core, binding the non-woven fiber web together while the core remains solid

Non-limiting examples of suitable materials that may be included in multicomponent and monocomponent binder fibers include poly(olefin)s such as poly(ethylene), poly(propylene), and poly(butylene); poly(ester)s and co-poly(ester)s such as poly(ethylene terephthalate) (e.g., amorphous poly(ethylene terephthalate)), co-poly(ethylene terephthalate), poly(butylene terephthalate), and poly(ethylene isophthalate); poly(amide)s and co-poly(amides) such as nylons and aramids; and halogenated polymers such as poly(tetrafluoroethylene). Suitable co-poly(ethylene terephthalate)s may comprise repeat units formed by the polymerization of ethylene terephthalate monomers and further comprise repeat units formed by the polymerization of one or more comonomers. Such comonomers may include linear, cyclic, and branched aliphatic dicarboxylic acids having 4-12 carbon atoms (e.g., butanedioic acid, pentanedioic acid, hexanedioic acid, dodecanedioic acid, and 1,4-cyclo-hexanedicarboxylic acid); aromatic dicarboxylic acids having 8-12 carbon atoms (e.g., isophthalic acid and 2,6-naphthalenedicarboxylic acid); linear, cyclic, and branched aliphatic diols having 3-8 carbon atoms (e.g., 1,3-propane diol, 1,2-propanediol, 1,4-butanediol, 3-methyl-1,5-pentanediol, 2,2-dimethyl-1,3-propanediol, 2-methyl-1,3-propanediol, and 1,4-cyclohexanediol); and/or aliphatic and aromatic/aliphatic ether glycols having 4-10 carbon atoms (e.g., hydroquinone bis(2-hydroxyethyl) ether and poly(ethylene ether) glycols having a molecular weight below 460 g/mol, such as diethylene ether glycol).

Non-limiting examples of suitable pairs of materials that may be included in bicomponent fibers include poly(ethylene)/poly(ethylene terephthalate), poly(propylene)/poly(ethylene terephthalate), co-poly(ethylene terephthalate)/poly(ethylene terephthalate), poly(butylene terephthalate)/poly(ethylene terephthalate), co-poly(amide)/poly(amide), and poly(ethylene)/poly(propylene). In the preceding list, the material having the lower melting temperature is listed first and the material having the higher melting temperature is listed second. Core-sheath bicomponent fibers comprising one of the above such pairs may have a sheath comprising the first material and a core comprising the second material.

In embodiments in which a non-woven fiber web comprises two or more types of bicomponent fibers, each type of bicomponent fiber may independently comprise one of the pairs of materials described above.

The monocomponent and multicomponent binder fibers described herein may have a variety of suitable melting points and/or comprise components having a variety of suitable melting points. In some embodiments, a non-woven fiber web comprises a monocomponent binder fiber having a melting point and/or a multicomponent fiber comprising a component having a melting point of greater than or equal to 80° C., greater than or equal to 90° C., greater than or equal to 100° C., greater than or equal to 110° C., greater than or equal to 120° C., greater than or equal to 130° C., greater than or equal to 140° C., greater than or equal to 150° C., greater than or equal to 160° C., greater than or equal to 170° C., greater than or equal to 180° C., greater than or equal to 190° C., greater than or equal to 200° C., greater than or equal to 210° C., or greater than or equal to 220° C. In some embodiments, a non-woven fiber web comprises a monocomponent binder fiber having a melting point and/or a multicomponent fiber comprising a component having a melting point less than or equal to 230° C., less than or equal to 220° C., less than or equal to 210° C., less than or equal to 200° C., less than or equal to 190° C., less than or equal to 180° C., less than or equal to 170° C., less than or equal to 160° C., less than or equal to 150° C., less than or equal to 140° C., less than or equal to 130° C., less than or equal to 120° C., less than or equal to 110° C., less than or equal to 100° C., or less than or equal to 90° C. Combinations of the above-referenced ranges are also possible (e.g., greater than or equal to 80° C. and less than or equal to 230° C., or greater than or equal to 110° C. and less than or equal to 230° C.). Other ranges are also possible.

The melting point of a monocomponent fiber and the melting points of the components of a multicomponent fiber may be determined by performing differential scanning calorimetry. The differential scanning calorimetry measurement may be carried out by heating the multicomponent fiber to 300° C. at 20° C./minute, cooling the multicomponent fiber to room temperature, and then determining the melting point during a reheating to 300° C. at 20° C./minute.

When present, the binder fibers may have a variety of suitable average diameters. In some embodiments, a non-woven fiber web comprises binder fibers having an average diameter of greater than or equal to 0.5 microns, greater than or equal to 0.75 microns, greater than or equal to 1 micron, greater than or equal to 2 microns, greater than or equal to 5 microns, greater than or equal to 7.5 microns, greater than or equal to 10 microns, greater than or equal to 15 microns, greater than or equal to 20 microns, greater than or equal to 25 microns, greater than or equal to 30 microns, greater than or equal to 35 microns, greater than or equal to 40 microns, or greater than or equal to 45 microns. In some embodiments, a non-woven fiber web comprises binder fibers having an average diameter of less than or equal to 50 microns, less than or equal to 45 microns, less than or equal to 40 microns, less than or equal to 35 microns, less than or equal to 30 microns, less than or equal to 25 microns, less than or equal to 20 microns, less than or equal to 15 microns, less than or equal to 10 microns, less than or equal to 7.5 microns, less than or equal to 5 microns, less than or equal to 2 microns, less than or equal to 1 micron, or less than or equal to 0.75 microns. Combinations of the above-referenced ranges are also possible (e.g., greater than or equal to 0.5 microns and less than or equal to 50 microns, greater than or equal to 1 micron and less than or equal to 50 microns, or greater than or equal to 2 microns and less than or equal to 50 microns). Other ranges are also possible.

When a non-woven fiber web comprises two or more types of binder fibers, each type of binder fiber may have an average diameter in one or more of the ranges described above. Additionally, in some embodiments, all of the binder fibers in a non-woven fiber web together have an average diameter in one or more of the ranges described above. Similarly, when a filter media comprises two or more non-woven fiber webs, each non-woven fiber web may independently comprise binder fibers (of one or more types independently, of all types together) having an average diameter in one or more of the ranges described above.

When present, the binder fibers may have a variety of suitable average lengths. In some embodiments, a non-woven fiber web comprises binder fibers having an average length of greater than or equal to 0.01 inch, greater than or equal to 0.02 inches, greater than or equal to 0.05 inches, greater than or equal to 0.075 inches, greater than or equal to 0.1 inch, greater than or equal to 0.2 inches, greater than or equal to 0.5 inches, greater than or equal to 0.75 inches, greater than or equal to 1 inch, greater than or equal to 1.25 inches, greater than or equal to 1.5 inches, greater than or equal to 2 inches, greater than or equal to 2.5 inches, greater than or equal to 3 inches, greater than or equal to 3.5 inches, greater than or equal to 4 inches, greater than or equal to 5 inches, greater than or equal to 6 inches, or greater than or equal to 8 inches. In some embodiments, a non-woven fiber web comprises binder fibers having an average length of less than or equal to 10 inches, less than or equal to 8 inches, less than or equal to 6 inches, less than or equal to 5 inches, less than or equal to 4 inches, less than or equal to 3.5 inches, less than or equal to 3 inches, less than or equal to 2.5 inches, less than or equal to 2 inches, less than or equal to 2.5 inches, less than or equal to 2 inches, less than or equal to 1.5 inches, less than or equal to 1.25 inches, less than or equal to 1 inch, less than or equal to 0.75 inches, less than or equal to 0.5 inches, less than or equal to 0.2 inches, less than or equal to 0.1 inch, less than or equal to 0.075 inches, less than or equal to 0.05 inches, or less than or equal to 0.02 inches. Combinations of the above-referenced ranges are also possible (e.g., greater than or equal to 0.01 inch and less than or equal to 10 inches, greater than or equal to 0.01 inch and less than or equal to 5 inches, or greater than or equal to 0.05 inches and less than or equal to 3 inches). Other ranges are also possible.

When a non-woven fiber web comprises two or more types of binder fibers, each type of binder fiber may have an average length in one or more of the ranges described above. Additionally, in some embodiments, all of the binder fibers in a non-woven fiber web together have an average length in one or more of the ranges described above. Similarly, when a filter media comprises two or more non-woven fiber webs, each non-woven fiber web may independently comprise binder fibers (of one or more types independently, of all types together) having an average length in one or more of the ranges described above.

In some embodiments, a non-woven fiber web comprises fibrillated fibers. The fibrillated fibers may comprise natural fibers and/or synthetic fibers as described elsewhere herein. A fibrillated fiber may include a parent fiber that branches into smaller diameter fibrils, which can, in some instances, branch further out into even smaller diameter fibrils with further branching also being possible. The branched nature of the fibrils may enhance the surface area of a fiber web in which the fibrillated fibers are employed, and can increase the number of contact points between the fibrillated fibers and other fibers in the non-woven fiber web. Such an increase in points of contact between the fibrillated fibers and other fibers in the non-woven fiber web may enhance the mechanical properties (e.g., flexibility, strength) of the non-woven fiber web.

When present, fibrillated fibers may comprise stems having average diameters in one or more of the ranges described elsewhere herein with respect to the average diameter of fibers of the relevant type (e.g., fibrillated synthetic fibers may comprise stems having average diameters in one or more of the ranges described elsewhere herein as possibly characterizing the average diameter of synthetic fibers, fibrillated natural fibers may comprise stems having average diameters in one or more of the ranges described elsewhere herein as possibly characterizing the average diameter of natural fibers).

When present, the fibrillated fibers may comprise fibrils having a variety of suitable diameters. In some embodiments, a non-woven fiber web comprises fibrillated fibers comprising fibrils having an average diameter of greater than or equal to 0.1 micron, greater than or equal to 0.2 microns, greater than or equal to 0.5 microns, greater than or equal to 0.75 microns, greater than or equal to 1 micron, greater than or equal to 1.25 microns, greater than or equal to 1.5 microns, or greater than or equal to 1.75 microns. In some embodiments, a non-woven fiber web comprises fibrillated fibers comprising fibrils having an average diameter of less than or equal to 2 microns, less than or equal to 1.75 microns, less than or equal to 1.5 microns, less than or equal to 1.25 microns, less than or equal to 1 micron, less than or equal to 0.75 microns, less than or equal to 0.5 microns, or less than or equal to 0.2 microns. Combinations of the above-referenced ranges are also possible (e.g., greater than or equal to 0.1 micron and less than or equal to 2 microns). Other ranges are also possible.

When a non-woven fiber web comprises two or more types of fibrillated fibers, each type of fibrillated fiber may comprise fibrils having an average diameter in one or more of the ranges described above. Additionally, in some embodiments, the fibrils of all of the fibrillated fibers in a non-woven fiber web together have an average diameter in one or more of the ranges described above. Similarly, when a filter media comprises two or more non-woven fiber webs, each non-woven fiber web may independently comprise fibrillated fibers (of one or more types independently, of all types together) comprising fibrils having an average diameter in one or more of the ranges described above.

When present, the fibrillated fibers may have a variety of suitable levels of fibrillation. In some embodiments, a non-woven fiber web comprises fibrillated fibers having a level of fibrillation of greater than or equal to 1 CSF, greater than or equal to 2 CSF, greater than or equal to 3 CSF, greater than or equal to 4 CSF, greater than or equal to 5 CSF, greater than or equal to 7.5 CSF, greater than or equal to 10 CSF, greater than or equal to 20 CSF, greater than or equal to 50 CSF, greater than or equal to 75 CSF, greater than or equal to 100 CSF, greater than or equal to 200 CSF, greater than or equal to 500 CSF, greater than or equal to 750 CSF, or greater than or equal to 900 CSF. In some embodiments, a non-woven fiber web comprises fibrillated fibers having a level of fibrillation of less than or equal to 1000 CSF, less than or equal to 900 CSF, less than or equal to 750 CSF, less than or equal to 500 CSF, less than or equal to 200 CSF, less than or equal to 100 CSF, less than or equal to 75 CSF, less than or equal to 50 CSF, less than or equal to 20 CSF, less than or equal to 10 CSF, less than or equal to 7.5 CSF, less than or equal to 5 CSF, less than or equal to 4 CSF, less than or equal to 3 CSF, or less than or equal to 2 CSF. Combinations of the above-referenced ranges are also possible (e.g., greater than or equal to 1 CSF and less than or equal to 1000 CSF, greater than or equal to 3 CSF and less than or equal to 1000 CSF, or greater than or equal to 5 CSF and less than or equal to 900 CSF). Other ranges are also possible.

The fibrillation of fibrillated fibers can be measured according to a Canadian Standard Freeness test, specified by TAPPI test method T-227-om-09 Freeness of pulp (2009). The test can provide an average CSF value.

When a non-woven fiber web comprises two or more types of fibrillated fibers, each type of fibrillated fiber may have a level of fibrillation in one or more of the ranges described above. Additionally, in some embodiments, all of the fibrillated fibers in a non-woven fiber web together have a level of fibrillation in one or more of the ranges described above. Similarly, when a filter media comprises two or more non-woven fiber webs, each non-woven fiber web may independently comprise fibrillated fibers (of one or more types independently, of all types together) having a level of fibrillation in one or more of the ranges described above.

In some embodiments, a filter media (e.g., comprising one or more of the above-described types of water-repellent additives, resins, and/or fibers) lacks certain fluorinated materials regulated by government bodies. For instance, in some embodiments, a filter media lacks perfluoroalkyl substances, polyfluoroalkyl substances, and/or fluorotelomers. As further examples, in some embodiments, a filter media lacks perfluoroalkane sulfonic acids (e.g., perfluoroalkane sulfonic acids comprising a carbon chain comprising six or more carbon atoms, such as perfluorohexane sulfonic acid and/or perfluorooctane sulfonic acid), perfluorocarboxylic acids (e.g., perfluorocarboxylic acids comprising a carbon chain comprising eight or more carbon atoms, such as perfluorooctanoic acid), perfluoroalkyl substances comprising a carbon chain comprising five or fewer carbon atoms (e.g., perfluorobutane sulfonic acid), perfluoroalkyl substances comprising a carbon chain comprising seven or fewer carbon atoms (e.g., perfluorohexanoic acid), and/or precursors that are capable of degrading to form any of the preceding species (e.g., long-chain perfluoroalkyl sulfonyl fluoride-based raw materials, fluorotelomers).

In some embodiments, a filter media (e.g., comprising one or more of the above-described types of water-repellent additives, resins, and/or fibers) comprises one or more fluorinated materials regulated by government bodies (e.g., one or more of the fluorinated materials described in the preceding paragraph) in a relatively small amount. The relevant fluorinated material may make up less than or equal to 15 wt %, less than or equal to 10 wt %, less than or equal to 7.5 wt %, less than or equal to 5 wt %, less than or equal to 2 wt %, less than or equal to 1 wt %, less than or equal to 0.1 wt %, or less than or equal to 0.01 wt % of the non-fibrous components of the filter media (e.g., any water-repellent additives and/or resins). The relevant fluorinated material may make up greater than or equal to 0 wt %, greater than or equal to 0.01 wt %, greater than or equal to 0.1 wt %, greater than or equal to 1 wt %, greater than or equal to 2 wt %, greater than or equal to 5 wt %, greater than or equal to 7.5 wt %, or greater than or equal to 10 wt % of the non-fibrous components of the filter media. Combinations of the above-referenced ranges are also possible (e.g., less than or equal to 15 wt % and greater than or equal to 0 wt %). In some embodiments, one or more fluorinated materials regulated by government bodies make up identically 0 wt % of the non-fibrous components of the filter media.

The non-woven fiber webs described herein may have a variety of suitable basis weights. In some embodiments, a non-woven fiber web has a basis weight of greater than or equal to 20 gsm, greater than or equal to 30 gsm, greater than or equal to 40 gsm, greater than or equal to 50 gsm, greater than or equal to 60 gsm, greater than or equal to 70 gsm, greater than or equal to 80 gsm, greater than or equal to 90 gsm, greater than or equal to 100 gsm, greater than or equal to 110 gsm, greater than or equal to 120 gsm, greater than or equal to 130 gsm, greater than or equal to 140 gsm, greater than or equal to 150 gsm, greater than or equal to 160 gsm, greater than or equal to 170 gsm, greater than or equal to 180 gsm, greater than or equal to 190 gsm, greater than or equal to 200 gsm, greater than or equal to 225 gsm, greater than or equal to 250 gsm, greater than or equal to 275 gsm, greater than or equal to 300 gsm, or greater than or equal to 350 gsm. In some embodiments, a non-woven fiber web has a basis weight of less than or equal to 400 gsm, less than or equal to 350 gsm, less than or equal to 300 gsm, less than or equal to 275 gsm, less than or equal to 250 gsm, less than or equal to 225 gsm, less than or equal to 200 gsm, less than or equal to 190 gsm, less than or equal to 180 gsm, less than or equal to 170 gsm, less than or equal to 160 gsm, less than or equal to 150 gsm, less than or equal to 140 gsm, less than or equal to 130 gsm, less than or equal to 120 gsm, less than or equal to 110 gsm, less than or equal to 100 gsm, less than or equal to 90 gsm, less than or equal to 80 gsm, less than or equal to 70 gsm, less than or equal to 60 gsm, less than or equal to 50 gsm, less than or equal to 40 gsm, or less than or equal to 30 gsm. Combinations of the above-referenced ranges are also possible (e.g., greater than or equal to 20 gsm and less than or equal to 400 gsm, greater than or equal to 20 gsm and less than or equal to 200 gsm, greater than or equal to 20 gsm and less than or equal to 150 gsm, or greater than or equal to 20 gsm and less than or equal to 130 gsm). Other ranges are also possible.

The basis weight of a non-woven fiber web may be determined in accordance with ISO 536:2012.

When a filter media comprises two or more non-woven fiber webs, each non-woven fiber web may independently have a basis weight in one or more of the above-described ranges.

The non-woven fiber webs described herein may have a variety of suitable thicknesses. In some embodiments, a non-woven fiber web has a thickness of greater than or equal to 100 microns, greater than or equal to 200 microns, greater than or equal to 500 microns, greater than or equal to 750 microns, greater than or equal to 1000 microns, greater than or equal to 2000 microns, greater than or equal to 3000 microns, or greater than or equal to 4000 microns. In some embodiments, a non-woven fiber web has a thickness of less than or equal to 5000 microns, less than or equal to 4000 microns, less than or equal to 3000 microns, less than or equal to 2000 microns, less than or equal to 1000 microns, less than or equal to 750 microns, less than or equal to 500 microns, or less than or equal to 200 microns. Combinations of the above-referenced ranges are also possible (e.g., greater than or equal to 200 microns and less than or equal to 5000 microns). Other ranges are also possible.

The thickness of a non-woven fiber web may be determined in accordance with ASTM D1777-96 (2019) under an applied pressure of 2 kPa.

When a filter media comprises two or more non-woven fiber webs, each non-woven fiber web may independently have a thickness in one or more of the above-described ranges.

The non-woven fiber webs described herein may have a variety of suitable mean flow pore sizes. In some embodiments, a non-woven fiber web has a mean flow pore size of greater than or equal to 0.5 microns, greater than or equal to 0.75 microns, greater than or equal to 1 micron, greater than or equal to 1.25 microns, greater than or equal to 1.5 microns, greater than or equal to 1.75 microns, greater than or equal to 2 microns, greater than or equal to 2.25 microns, greater than or equal to 2.5 microns, greater than or equal to 3 microns, greater than or equal to 4 microns, greater than or equal to 5 microns, greater than or equal to 7.5 microns, greater than or equal to 10 microns, greater than or equal to 12.5 microns, greater than or equal to 15 microns, greater than or equal to 17.5 microns, greater than or equal to 20 microns, or greater than or equal to 25 microns. In some embodiments, a non-woven fiber web has a mean flow pore size of less than or equal to 30 microns, less than or equal to 25 microns, less than or equal to 20 microns, less than or equal to 17.5 microns, less than or equal to 15 microns, less than or equal to 12.5 microns, less than or equal to 10 microns, less than or equal to 7.5 microns, less than or equal to 5 microns, less than or equal to 4 microns, less than or equal to 3 microns, less than or equal to 2.5 microns, less than or equal to 2.25 microns, less than or equal to 2 microns, less than or equal to 1.75 microns, less than or equal to 1.5 microns, less than or equal to 1.25 microns, less than or equal to 1 micron, or less than or equal to 0.75 microns. Combinations of the above-referenced ranges are also possible (e.g., greater than or equal to 0.5 microns and less than or equal to 30 microns, or greater than or equal to 1 micron and less than or equal to 15 microns). Other ranges are also possible.

The mean flow pore size of a non-woven fiber web may be determined in accordance with ASTM F316-90 Method B (2019).

When a filter media comprises two or more non-woven fiber webs, each non-woven fiber web may independently have a mean flow pore size in one or more of the above-described ranges.

The non-woven fiber webs described herein may have a variety of suitable maximum pore sizes. In some embodiments, a non-woven fiber web has a maximum pore size of greater than or equal to 1.5 microns, greater than or equal to 1.75 microns, greater than or equal to 2 microns, greater than or equal to 2.5 microns, greater than or equal to 3 microns, greater than or equal to 4 microns, greater than or equal to 5 microns, greater than or equal to 6 microns, greater than or equal to 8 microns, greater than or equal to 10 microns, greater than or equal to 12.5 microns, greater than or equal to 15 microns, greater than or equal to 17.5 microns, greater than or equal to 20 microns, greater than or equal to 25 microns, greater than or equal to 30 microns, greater than or equal to 35 microns, greater than or equal to 40 microns, or greater than or equal to 45 microns. In some embodiments, a non-woven fiber web has a maximum pore size of less than or equal to 50 microns, less than or equal to 45 microns, less than or equal to 40 microns, less than or equal to 35 microns, less than or equal to 30 microns, less than or equal to 25 microns, less than or equal to 20 microns, less than or equal to 17.5 microns, less than or equal to 15 microns, less than or equal to 12.5 microns, less than or equal to 10 microns, less than or equal to 8 microns, less than or equal to 6 microns, less than or equal to 5 microns, less than or equal to 4 microns, less than or equal to 3 microns, less than or equal to 2.5 microns, less than or equal to 2 microns, or less than or equal to 1.75 microns. Combinations of the above-referenced ranges are also possible (e.g., greater than or equal to 1.5 microns and less than or equal to 50 microns, or greater than or equal to 2.5 microns and less than or equal to 40 microns). Other ranges are also possible.

The maximum pore size of a non-woven fiber web may be determined in accordance with ASTM F316-90 Method B (2019).

When a filter media comprises two or more non-woven fiber webs, each non-woven fiber web may independently have a maximum pore size in one or more of the above-described ranges.

The non-woven fiber webs described herein may have a variety of suitable air resistances. In some embodiments, a non-woven fiber web has an air resistance of greater than or equal to 2 Pa, greater than or equal to 5 Pa, greater than or equal to 7.5 Pa, greater than or equal to 10 Pa, greater than or equal to 20 Pa, greater than or equal to 50 Pa, greater than or equal to 75 Pa, greater than or equal to 100 Pa, greater than or equal to 200 Pa, greater than or equal to 300 Pa, greater than or equal to 400 Pa, greater than or equal to 500 Pa, greater than or equal to 600 Pa, or greater than or equal to 700 Pa. In some embodiments, a non-woven fiber web has an air resistance of less than or equal to 800 Pa, less than or equal to 700 Pa, less than or equal to 600 Pa, less than or equal to 500 Pa, less than or equal to 400 Pa, less than or equal to 300 Pa, less than or equal to 200 Pa, less than or equal to 100 Pa, less than or equal to 75 Pa, less than or equal to 50 Pa, less than or equal to 20 Pa, less than or equal to 10 Pa, less than or equal to 7.5 Pa, or less than or equal to 5 Pa. Combinations of the above-referenced ranges are also possible (e.g., greater than or equal to 2 Pa and less than or equal to 800 Pa). Other ranges are also possible.

The air resistance of a non-woven fiber web may be determined by measuring the air permeability in CFM (cfm/sf) of the non-woven fiber web using a FX 3300 Air Permeability Tester III from TEXTEST Instruments and then dividing 113.5 by the measured air permeability. The air permeability measurement may be performed in accordance with ASTM D737-04 (2016) at a pressure of 125 Pa and a face velocity of 5.33 cm/s.

When a filter media comprises two or more non-woven fiber webs, each non-woven fiber web may independently have an air resistance in one or more of the above-described ranges.

As described above, in some embodiments, a filter media comprises one or more further layers in addition to a main filter layer. For instance, a filter media may further comprise a prefilter layer, a support layer, a scrim, and/or further main filter layers. Non-limiting examples of suitable layer types for such layers include meltblown non-woven fiber webs, electrospun non-woven fiber webs, wet laid non-woven fiber webs, carded non-woven fiber webs, and other non-wet laid non-woven fiber webs. Such layers may be laminated to each other and/or to a main filter layer.

The filter media as a whole may have a variety of suitable properties. Further details regarding properties some filter media may have are provided below.

The filter media described herein may have a variety of suitable basis weights. In some embodiments, a filter media has a basis weight of greater than or equal to 20 gsm, greater than or equal to 30 gsm, greater than or equal to 40 gsm, greater than or equal to 50 gsm, greater than or equal to 60 gsm, greater than or equal to 70 gsm, greater than or equal to 80 gsm, greater than or equal to 90 gsm, greater than or equal to 100 gsm, greater than or equal to 110 gsm, greater than or equal to 120 gsm, greater than or equal to 130 gsm, greater than or equal to 140 gsm, greater than or equal to 150 gsm, greater than or equal to 160 gsm, greater than or equal to 170 gsm, greater than or equal to 180 gsm, greater than or equal to 190 gsm, greater than or equal to 200 gsm, greater than or equal to 225 gsm, greater than or equal to 250 gsm, greater than or equal to 275 gsm, greater than or equal to 300 gsm, or greater than or equal to 350 gsm. In some embodiments, a filter media has a basis weight of less than or equal to 400 gsm, less than or equal to 350 gsm, less than or equal to 300 gsm, less than or equal to 275 gsm, less than or equal to 250 gsm, less than or equal to 225 gsm, less than or equal to 200 gsm, less than or equal to 190 gsm, less than or equal to 180 gsm, less than or equal to 170 gsm, less than or equal to 160 gsm, less than or equal to 150 gsm, less than or equal to 140 gsm, less than or equal to 130 gsm, less than or equal to 120 gsm, less than or equal to 110 gsm, less than or equal to 100 gsm, less than or equal to 90 gsm, less than or equal to 80 gsm, less than or equal to 70 gsm, less than or equal to 60 gsm, less than or equal to 50 gsm, less than or equal to 40 gsm, or less than or equal to 30 gsm. Combinations of the above-referenced ranges are also possible (e.g., greater than or equal to 20 gsm and less than or equal to 400 gsm, greater than or equal to 20 gsm and less than or equal to 200 gsm, greater than or equal to 20 gsm and less than or equal to 150 gsm, or greater than or equal to 20 gsm and less than or equal to 130 gsm). Other ranges are also possible.

The basis weight of a filter media may be determined in accordance with ISO 536:2012.

The filter media described herein may have a variety of suitable thicknesses. In some embodiments, a filter media has a thickness of greater than or equal to 100 microns, greater than or equal to 200 microns, greater than or equal to 500 microns, greater than or equal to 750 microns, greater than or equal to 1000 microns, greater than or equal to 2000 microns, greater than or equal to 3000 microns, or greater than or equal to 4000 microns. In some embodiments, a filter media has a thickness of less than or equal to 5000 microns, less than or equal to 4000 microns, less than or equal to 3000 microns, less than or equal to 2000 microns, less than or equal to 1000 microns, less than or equal to 750 microns, less than or equal to 500 microns, or less than or equal to 200 microns. Combinations of the above-referenced ranges are also possible (e.g., greater than or equal to 200 microns and less than or equal to 5000 microns). Other ranges are also possible.

The thickness of filter media may be determined in accordance with ASTM D1777-96 (2019) under an applied pressure of 2 kPa.

The filter media described herein may have a variety of suitable mean flow pore sizes. In some embodiments, a filter media has a mean flow pore size of greater than or equal to 0.5 microns, greater than or equal to 0.75 microns, greater than or equal to 1 micron, greater than or equal to 1.25 microns, greater than or equal to 1.5 microns, greater than or equal to 1.75 microns, greater than or equal to 2 microns, greater than or equal to 2.25 microns, greater than or equal to 2.5 microns, greater than or equal to 3 microns, greater than or equal to 4 microns, greater than or equal to 5 microns, greater than or equal to 7.5 microns, greater than or equal to 10 microns, greater than or equal to 12.5 microns, greater than or equal to 15 microns, greater than or equal to 17.5 microns, greater than or equal to 20 microns, greater than or equal to 25 microns, or greater than or equal to 30 microns. In some embodiments, a filter media has a mean flow pore size of less than or equal to 35 microns, less than or equal to 30 microns, less than or equal to 25 microns, less than or equal to 20 microns, less than or equal to 17.5 microns, less than or equal to 15 microns, less than or equal to 12.5 microns, less than or equal to 10 microns, less than or equal to 7.5 microns, less than or equal to 5 microns, less than or equal to 4 microns, less than or equal to 3 microns, less than or equal to 2.5 microns, less than or equal to 2.25 microns, less than or equal to 2 microns, less than or equal to 1.75 microns, less than or equal to 1.5 microns, less than or equal to 1.25 microns, less than or equal to 1 micron, or less than or equal to 0.75 microns. Combinations of the above-referenced ranges are also possible (e.g., greater than or equal to 0.5 microns and less than or equal to 35 microns, or greater than or equal to 1 micron and less than or equal to 15 microns). Other ranges are also possible.

The mean flow pore size of a filter media may be determined in accordance with ASTM F316-90 Method B (2019).

The filter media described herein may have a variety of suitable maximum pore sizes. In some embodiments, a filter media has a maximum pore size of greater than or equal to 1.5 microns, greater than or equal to 1.75 microns, greater than or equal to 2 microns, greater than or equal to 2.5 microns, greater than or equal to 3 microns, greater than or equal to 4 microns, greater than or equal to 5 microns, greater than or equal to 6 microns, greater than or equal to 8 microns, greater than or equal to 10 microns, greater than or equal to 12.5 microns, greater than or equal to 15 microns, greater than or equal to 17.5 microns, greater than or equal to 20 microns, greater than or equal to 25 microns, greater than or equal to 30 microns, greater than or equal to 35 microns, greater than or equal to 40 microns, or greater than or equal to 45 microns. In some embodiments, a filter media has a maximum pore size of less than or equal to 50 microns, less than or equal to 45 microns, less than or equal to 40 microns, less than or equal to 35 microns, less than or equal to 30 microns, less than or equal to 25 microns, less than or equal to 20 microns, less than or equal to 17.5 microns, less than or equal to 15 microns, less than or equal to 12.5 microns, less than or equal to 10 microns, less than or equal to 8 microns, less than or equal to 6 microns, less than or equal to 5 microns, less than or equal to 4 microns, less than or equal to 3 microns, less than or equal to 2.5 microns, less than or equal to 2 microns, or less than or equal to 1.75 microns. Combinations of the above-referenced ranges are also possible (e.g., greater than or equal to 1.5 microns and less than or equal to 50 microns, or greater than or equal to 2.5 microns and less than or equal to 40 microns). Other ranges are also possible.

The maximum pore size of a filter media may be determined in accordance with ASTM F316-90 Method B (2019).

Some filter media described herein may have relatively high water repellencies. In some embodiments, a filter media has a water repellency of greater than or equal to 4 inches H₂O, greater than or equal to 4.5 inches H₂O, greater than or equal to 5 inches H₂O, greater than or equal to 5.5 inches H₂O, greater than or equal to 6 inches H₂O, greater than or equal to 7 inches H₂O, greater than or equal to 8 inches H₂O, greater than or equal to 9 inches H₂O, greater than or equal to 10 inches H₂O, greater than or equal to 12.5 inches H₂O, greater than or equal to 15 inches H₂O, greater than or equal to 20 inches H₂O, greater than or equal to 30 inches H₂O, greater than or equal to 40 inches H₂O, greater than or equal to 50 inches H₂O, greater than or equal to 75 inches H₂O, greater than or equal to 100 inches H₂O, greater than or equal to 125 inches H₂O, greater than or equal to 150 inches H₂O, greater than or equal to 175 inches H₂O, greater than or equal to 200 inches H₂O, greater than or equal to 225 inches H₂O, greater than or equal to 250 inches H₂O, or greater than or equal to 275 inches H₂O. In some embodiments, a filter media has a water repellency of less than or equal to 300 inches H₂O, less than or equal to 275 inches H₂O, less than or equal to 250 inches H₂O, less than or equal to 225 inches H₂O, less than or equal to 200 inches H₂O, less than or equal to 175 inches H₂O, less than or equal to 150 inches H₂O, less than or equal to 125 inches H₂O, less than or equal to 100 inches H₂O, less than or equal to 75 inches H₂O, less than or equal to 50 inches H₂O, less than or equal to 40 inches H₂O, less than or equal to 30 inches H₂O, less than or equal to 20 inches H₂O, less than or equal to 15 inches H₂O, less than or equal to 12.5 inches H₂O, less than or equal to 10 inches H₂O, less than or equal to 9 inches H₂O, less than or equal to 8 inches H₂O, less than or equal to 7 inches H₂O, less than or equal to 6 inches H₂O, less than or equal to 5.5 inches H₂O, less than or equal to 5 inches H₂O, or less than or equal to 4.5 inches H₂O. Combinations of the above-referenced ranges are also possible (e.g., greater than or equal to 4 inches H₂O and less than or equal to 300 inches H₂O, greater than or equal to 5 inches H₂O and less than or equal to 200 inches H₂O, or greater than or equal to 10 inches H₂O and less than or equal to 150 inches H₂O). Other ranges are also possible.

The water repellency of a filter media may be determined by performing a Hydrostatic Head Test (HHT), which determines the height of water that the media will support before a predetermined amount of liquid passes through. Filter media with higher values measured by the HHT exhibit greater barriers to liquid penetration than filter media with lower values measured by the HHT. The HHT may be performed according to the standards BS EN 20811:1992 (British), EN 20811:1992, and ISO 811:1981 (international) for determining resistance to water penetration on a FX3000 Hydrotester III instrument.

In some embodiments, a filter media can be characterized by a title that indicates an efficiency level within a certain range. As one example, a filter media may be a high efficiency particulate air (HEPA) or ultra low particulate air (ULPA) filter. These filters are required to remove particulates at an efficiency level specified by EN1822:2009. In some embodiments, the filter media removes particulates at the most penetrating particle size (the particle size with the highest penetration) at an efficiency of greater than 99.95% (H 13), greater than 99.995% (H 14), greater than 99.9995% (U 15), greater than 99.99995% (U 16), or greater than 99.999995% (U 17). It is also possible for a filter media described herein to be an M5, M6, F7, F8, F9, E10, Ell, or E12 filter media as per EN 779 (2012) and/or EN 1822:2009. These filter media must exhibit efficiencies of 40%-60% for 0.4 micron diameter particles, 60%-80% for 0.4 micron diameter particles, 80%-90% for 0.4 micron diameter particles, 90%-95% for 0.4 micron diameter particles, greater than or equal to 95% for 0.4 micron diameter particles, greater than or equal to 85% for particles at the most penetrating particle size, greater than or equal to 95% for particles at the most penetrating particle size, and greater than or equal to 99.5% for particles at the most penetrating particle size, respectively. As a third example, a filter media may be an ePM1, ePM2.5, ePM10 or ISO Coarse filter media as per ISO 16890. As a fourth example, a filter media may be a MERV 8, MERV 9, MERV 10, MERV 11, MERV 12, MERV 13, MERV 14, MERV 15, or MERV 16 filter media as per ANSI and ASHRAE 52.2.

In some embodiments, a filter media described herein has a relatively high value of initial dioctyl phthalate (DOP) gamma. The initial DOP gamma may be measured at 0.3 microns for filter media having an efficiency of less than or equal to 99.95%, may be measured at 0.19 microns for filter media having an efficiency of greater than 99.95% and less than 99.995%, and may be measured at the most penetrating particle size for filter media having an efficiency of greater than or equal to 99.995%. The initial DOP gamma at a particular particle size (e.g., 0.3 microns, 0.19 microns, most penetrating particle size) is defined by the following formula: DOP gamma=(−log₁₀(initial DOP penetration at particle size, %/100%)/(initial air resistance, mm H₂O))×100.

Penetration, often expressed as a percentage, is defined as follows: Pen(%)=(C/C₀)*100% where C is the particle concentration after passage through the filter media and Co is the particle concentration before passage through the filter media. The initial penetration for DOP particles of a particular size may be measured by blowing DOP particles of that size through a filter media and measuring the percentage of particles that penetrate therethrough.

The testing for 0.3 micron diameter particles may be performed in accordance with ASTM D2986 (1999). One exemplary method for carrying out this testing follows, but other such methods are also possible. A TDA-100P automated penetrometer and filter tester available from Air Techniques International may be employed to blow DOP particles at a 100 cm² face area of the upstream face of the filter media with a face velocity of 5.33 cm/s. The DOP particles may have a mass mean diameter of 0.3 microns (and also have a 0.18 micron count median diameter and a geometric standard deviation of less than 1.6 microns). The upstream and downstream particle concentrations may be measured by use of condensation particle counters. The DOP particles may be blown at the upstream face of the filter media until the penetration reading is determined to be stable by the TDA-100P automated penetrometer and filter tester.

The testing for 0.19 micron diameter particles may be performed by methods known to those in the art. One exemplary such method follows. Briefly, a TSI 3160 may be employed to blow DOP particles through a filter media at a 100 cm² face area of the upstream face of the filter media with a face velocity of 2.5 cm/s and an air flow of 12 L/min. The DOP particles may have an average particle diameter of 0.19 microns. The DOP particles may be blown at the upstream face of the filter media for a period of time between 20 seconds and 400 seconds and such that at least 70 downstream counts are obtained. The upstream and downstream particle concentrations may be measured throughout the measurement period by condensation particle counters, and the total upstream and downstream particle counts across the measurement period may be employed to calculate the gamma value.

The testing for penetration at the most penetrating particle size may be performed by methods known to those in the art. One exemplary such method follows. In this method, the procedure described above for 0.19 micron diameter particles is followed, except that DOP particles having a range of sizes may be blown at the upstream face of the filter media. The particle size for which the highest penetration is measured is then considered the most penetrating particle size, and the penetration at that particle size is employed in the gamma calculation. For such analysis, the TSI 3160 may instead be employed to sequentially blow populations of DOP particles with varying average particle diameters at a 100 cm² portion of the upstream face of the filter media. The populations of particles may be blown at the upstream face of the filter media in order of increasing average diameter, and may have the following set of average diameters: 0.03 microns, 0.06 microns, 0.08 microns, 0.13 microns, and 0.2 microns. Each population of particles may be blown in the same manner as described in the immediately preceding paragraph.

The air resistance of a filter media may be determined by the same procedure described elsewhere herein with respect to the air resistance of a non-woven fiber web.

In some embodiments, a filter media has an initial DOP gamma of greater than or equal to 6, greater than or equal to 6.5, greater than or equal to 7, greater than or equal to 7.5, greater than or equal to 8, greater than or equal to 8.5, greater than or equal to 9, greater than or equal to 9.5, greater than or equal to 10, greater than or equal to 11, greater than or equal to 12, greater than or equal to 13, greater than or equal to 14, greater than or equal to 15, greater than or equal to 17.5, greater than or equal to 20, greater than or equal to 22.5, greater than or equal to 25, or greater than or equal to 27.5. In some embodiments, a filter media has an initial DOP gamma of less than or equal to 30, less than or equal to 27.5, less than or equal to 25, less than or equal to 22.5, less than or equal to 20, less than or equal to 17.5, less than or equal to 15, less than or equal to 14, less than or equal to 13, less than or equal to 12, less than or equal to 11, less than or equal to 10, less than or equal to 9.5, less than or equal to 9, less than or equal to 8.5, less than or equal to 8, less than or equal to 7.5, less than or equal to 7, or less than or equal to 6.5. Combinations of the above-referenced ranges are also possible (e.g., greater than or equal to 6 and less than or equal to 35, greater than or equal to 8 and less than or equal to 30, greater than or equal to 9 and less than or equal to 30, greater than or equal to 9 and less than or equal to 25, or greater than or equal to 10 and less than or equal to 25). Other ranges are also possible.

The filter media described herein may have a variety of suitable air resistances. In some embodiments, a filter media has an air resistance of greater than or equal to 2 Pa, greater than or equal to 5 Pa, greater than or equal to 7.5 Pa, greater than or equal to 10 Pa, greater than or equal to 20 Pa, greater than or equal to 50 Pa, greater than or equal to 75 Pa, greater than or equal to 100 Pa, greater than or equal to 200 Pa, greater than or equal to 300 Pa, greater than or equal to 400 Pa, greater than or equal to 500 Pa, greater than or equal to 600 Pa, or greater than or equal to 700 Pa. In some embodiments, a filter media has an air resistance of less than or equal to 800 Pa, less than or equal to 700 Pa, less than or equal to 600 Pa, less than or equal to 500 Pa, less than or equal to 400 Pa, less than or equal to 300 Pa, less than or equal to 200 Pa, less than or equal to 100 Pa, less than or equal to 75 Pa, less than or equal to 50 Pa, less than or equal to 20 Pa, less than or equal to 10 Pa, less than or equal to 7.5 Pa, or less than or equal to 5 Pa. Combinations of the above-referenced ranges are also possible (e.g., greater than or equal to 2 Pa and less than or equal to 800 Pa). Other ranges are also possible.

The filter media described herein may be suitable for a variety of applications. Some filter media described herein are suitable for air filtration and/or are positioned in air filters. As described elsewhere herein, some filter media are suitable for HEPA and/or ULPA filters. Further examples of suitable types of filters that the filter media described herein may be positioned in include HVAC filters, heavy duty air filters, and gas turbine filters.

In some embodiments, a filter media described herein may be a component of a filter element. That is, the filter media may be incorporated into an article suitable for use by an end user.

Non-limiting examples of suitable filter elements include flat panel filters, V-bank filters (comprising, e.g., between 1 and 24 Vs), cartridge filters, cylindrical filters, and conical filters. Filter elements may have any suitable height (e.g., between 2 in and 124 in for flat panel filters, between 4 in and 124 in for V-bank filters, between 1 in and 124 in for cartridge and cylindrical filter media). Filter elements may also have any suitable width (between 2 in and 124 in for flat panel filters, between 4 in and 124 in for V-bank filters). Some filter media (e.g., cartridge filter media, cylindrical filter media) may be characterized by a diameter instead of a width; these filter media may have a diameter of any suitable value (e.g., between 1 in and 124 in). Filter elements typically comprise a frame, which may be made of one or more materials such as cardboard, aluminum, steel, alloys, wood, and polymers.

In some embodiments, a filter media described herein may be a component of a filter element and may be pleated. The pleat height and pleat density (number of pleats per unit length of the media) may be selected as desired. In some embodiments, the pleat height may be greater than or equal to 10 mm, greater than or equal to 15 mm, greater than or equal to 20 mm, greater than or equal to 25 mm, greater than or equal to 30 mm, greater than or equal to 35 mm, greater than or equal to 40 mm, greater than or equal to 45 mm, greater than or equal to 50 mm, greater than or equal to 53 mm, greater than or equal to 55 mm, greater than or equal to 60 mm, greater than or equal to 65 mm, greater than or equal to 70 mm, greater than or equal to 75 mm, greater than or equal to 80 mm, greater than or equal to 85 mm, greater than or equal to 90 mm, greater than or equal to 95 mm, greater than or equal to 100 mm, greater than or equal to 125 mm, greater than or equal to 150 mm, greater than or equal to 175 mm, greater than or equal to 200 mm, greater than or equal to 225 mm, greater than or equal to 250 mm, greater than or equal to 275 mm, greater than or equal to 300 mm, greater than or equal to 325 mm, greater than or equal to 350 mm, greater than or equal to 375 mm, greater than or equal to 400 mm, greater than or equal to 425 mm, greater than or equal to 450 mm, greater than or equal to 475 mm, or greater than or equal to 500 mm. In some embodiments, the pleat height is less than or equal to 510 mm, less than or equal to 500 mm, less than or equal to 475 mm, less than or equal to 450 mm, less than or equal to 425 mm, less than or equal to 400 mm, less than or equal to 375 mm, less than or equal to 350 mm, less than or equal to 325 mm, less than or equal to 300 mm, less than or equal to 275 mm, less than or equal to 250 mm, less than or equal to 225 mm, less than or equal to 200 mm, less than or equal to 175 mm, less than or equal to 150 mm, less than or equal to 125 mm, less than or equal to 100 mm, less than or equal to 95 mm, less than or equal to 90 mm, less than or equal to 85 mm, less than or equal to 80 mm, less than or equal to 75 mm, less than or equal to 70 mm, less than or equal to 65 mm, less than or equal to 60 mm, less than or equal to 55 mm, less than or equal to 53 mm, less than or equal to 50 mm, less than or equal to 45 mm, less than or equal to 40 mm, less than or equal to 35 mm, less than or equal to 30 mm, less than or equal to 25 mm, less than or equal to 20 mm, or less than or equal to 15 mm. Combinations of the above-referenced ranges are also possible (e.g., greater than or equal to 10 mm and less than or equal to 510 mm, or greater than or equal to 10 mm and less than or equal to 100 mm). Other ranges are also possible.

In some embodiments, a filter media has a pleat density of greater than or equal to 5 pleats per 100 mm, greater than or equal to 6 pleats per 100 mm, greater than or equal to 10 pleats per 100 mm, greater than or equal to 15 pleats per 100 mm, greater than or equal to 20 pleats per 100 mm, greater than or equal to 25 pleats per 100 mm, greater than or equal to 28 pleats per 100 mm, greater than or equal to 30 pleats per 100 mm, or greater than or equal to 35 pleats per 100 mm. In some embodiments, a filter media has a pleat density of less than or equal to 40 pleats per 100 mm, less than or equal to 35 pleats per 100 mm, less than or equal to 30 pleats per 100 mm, less than or equal to 28 pleats per 100 mm, less than or equal to 25 pleats per 100 mm, less than or equal to 20 pleats per 100 mm, less than or equal to 15 pleats per 100 mm, less than or equal to 10 pleats per 100 mm, or less than or equal to 6 pleats per 100 mm. Combinations of the above-referenced ranges are also possible (e.g., greater than or equal to 5 pleats per 100 mm and less than or equal to 40 pleats per 100 mm, greater than or equal to 6 pleats per 100 mm and less than or equal to 40 pleats per 100 mm, or greater than or equal to 25 pleats per 100 mm and less than or equal to 28 pleats per 100 mm). Other ranges are also possible.

Other pleat heights and densities may also be possible. For instance, filter media within flat panel or V-bank filters may have pleat heights between ¼ in and 24 in, and/or pleat densities between 1 pleat/in and 50 pleats/in. As another example, filter media within cartridge filters or conical filters may have pleat heights between ¼ in and 24 in and/or pleat densities between ½ pleats/in and 100 pleats/in. In some embodiments, pleats are separated by a pleat separator made of, e.g., polymer, glass, aluminum, and/or cotton. In other embodiments, the filter element lacks a pleat separator. The filter media may be wire-backed, or it may be self-supporting.

### EXAMPLE 1

This Example describes the fabrication and testing of filter media comprising additives having different functional groups.

Each filter media was fabricated by introducing a fluid comprising a precursor to an H 14 filter media comprising microglass fibers and chopped strand glass fibers. The precursors employed included methyltrimethoxysilane, n-propyltrimethoxysilane, n-octyltrimethoxysilane, hexadecyltrimethoxysilane, and octadecyltrimethoxysilane. The fluid comprising the precursor was formed by mixing the precursor with water for five minutes in a laboratory mixer to form a 0.3 wt % solution or dispersion of the precursor in water. The H 14 filter media was disposed on a wire, and the H 14 filter media and the wire were then dipped together into the fluid comprising the precursor for ten seconds. After removal from the fluid comprising the precursor, the H 14 filter media and the wire were exposed to a vacuum and then dried on a photodryer. Finally, the precursor-coated H 14 filter media was cured and then post-cured in an oven to form the final filter media including the cured water-repellent additive.

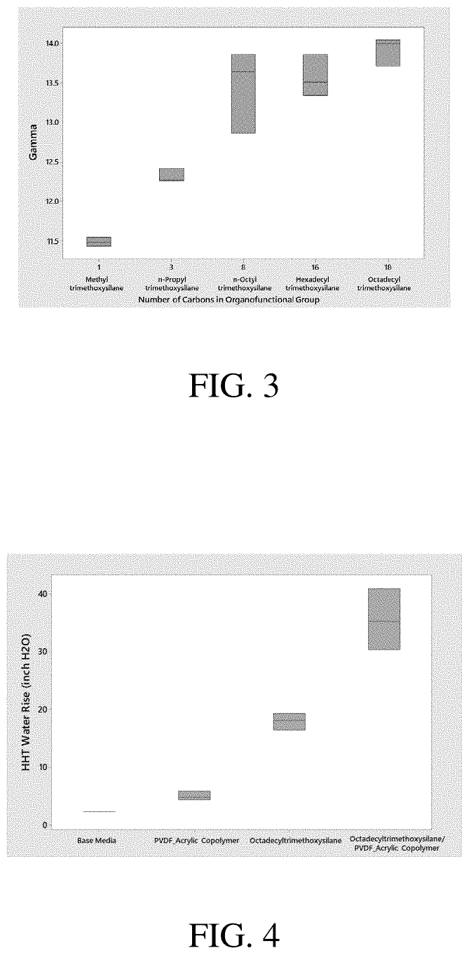

FIG. 3 shows the gamma values for each of the filter media comprising an additive formed from one of the precursors described in the preceding paragraph. In this FIG., the labels provided identify the precursor. As can be seen from the data shown therein, filter media comprising additives formed from precursors having longer water-repellent functional groups had higher values of gamma than filter media comprising water-repellent additives having shorter water-repellent functional groups.

The water repellency of each filter media was also measured. The values observed were all sufficiently high to allow the filter media to be suitable for applications where water repellency is needed (e.g., in excess of 10 inches H₂O).

### EXAMPLE 2

This Example describes the fabrication and testing of a filter media comprising a water-repellent additive and a fluorinated resin. This filter media was compared to filter media lacking either or both of these species.

The filter media comprising both the water-repellent additive and the fluorinated resin was fabricated as described in Example 1, except that a dispersion of the resin and the water-repellent additive was prepared and mixed instead of a mixture of just the water-repellent additive in water. The mixture was 1.5 wt % solids and the water-repellent additive made up 20 wt % of the mixture. The resin employed was a PVDF-acrylic copolymer. The precursor employed was octadecyltrimethoxysilane. After exposure to the mixture, the non-woven fiber web weighed 4-5% more than it did prior to the exposure. The filter media comprising just the fluorinated resin was prepared in this same manner except that the water-repellent additive was not included in the dispersion. The filter media comprising just the water-repellent additive was fabricated as described in Example 1.

FIG. 4 shows the water repellency for various filter media. From FIG. 4, it is seen that filter media comprising both an additive formed from octadecyltrimethoxysilane and a PVDF-acrylic copolymer resin had an increased water repellency in comparison to filter media lacking either or both species (the latter denoted by “Base Media”). Accordingly, the PVDF-acrylic copolymer and octadecyltrimethoxysilane are believed to act synergistically.

### EXAMPLE 3

This Example describes the fabrication and testing of filter media comprising a water-repellent additive and an additive comprising a polar functional group. The filter media further comprised a PVDF-acrylic copolymer. This filter media was compared to filter media lacking the additive comprising the polar functional group.

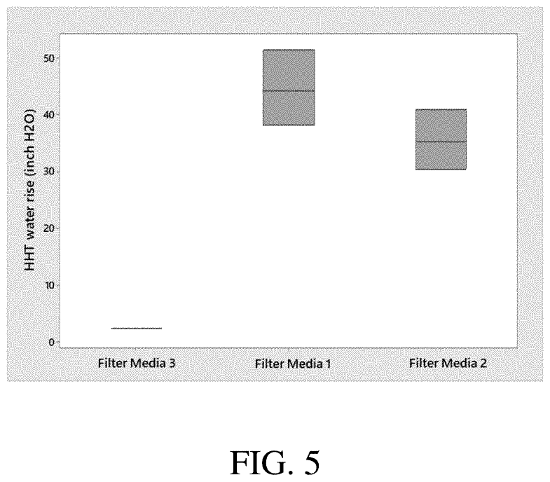

The filter media were fabricated as described in Example 2, except that each additive made up 10 wt % of the mixture. The water-repellent additive was octadecyltrimethoxysilane and the additive comprising the polar functional group was aminopropyltrimethoxysilane. FIG. 5 shows the water-repellency of the three filter media tested. From FIG. 5, it is clear that the filter media comprising all three species (Filter Media 1) had a higher water repellency than both the filter media lacking the aminopropyltrimethoxyilane (Filter Media 2) and the filter media lacking both additives and the PVDF-acrylic copolymer (Filter Media 3).

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A filter media, comprising:
a non-woven fiber web; and
a water-repellent additive, wherein:
the water-repellent additive comprises one or more water-repellent functional groups;
each water-repellent functional group is independently an alkyl group comprising greater than or equal to 3 carbon atoms, an alkenyl group comprising greater than or equal to 3 carbon atoms, and/or an alkynyl group comprising greater than or equal to 3 carbon atoms;
each water-repellent functional group is independently a side chain of a repeat unit of a polymer and/or bonded to a silicon atom and/or a metal atom;
the filter media has a gamma of greater than 6; and
the filter media has a water repellency of greater than 4 inches H₂O.

2. A filter media as in claim 1, wherein the metal is titanium, zirconium, and/or aluminum.

3. A filter media as in claim 1, wherein the water-repellent additive is a reaction product of a silane, a titanate, a zirconate, and/or an aluminate.

4-6. (canceled)

7. A filter media as in claim 1, wherein the polymer is a poly(siloxane), a poly(silazane), a poly(acrylate), a poly(urethane), a poly(ether), a poly(urea), a poly(ester), a poly(carbodiimide).

8-14. (canceled)

15. A filter media as in claim 1, wherein the polymer is a hydrolysis product of a species comprising a metal atom, a hydrolysable functional group, and a water-repellent functional group.

16. A filter media as in claim 1, wherein the water-repellent additive comprises a silanol, a siloxide, a siloxane, and/or a silyl ether.

17-29. (canceled)

30. A filter media as in claim 1, wherein the filter media comprises a resin.

31. A filter media as in claim 30, wherein the resin comprises a copolymer comprising a fluorinated repeat unit and a non-fluorinated repeat unit.

32-36. (canceled)

37. A filter media as in claim 30, wherein the resin comprises poly(vinylidene difluoride).

38. A filter media as in claim 30, wherein the resin comprises a poly(vinylidene difluoride)-acrylic copolymer.

39-40. (canceled)

41. A filter media as in claim 1, wherein the water-repellent additive comprises one or more polar, non-hydrolysable groups.

42. A filter media as in claim 41, wherein the one or more polar, non-hydrolysable groups are each independently bonded to a carbon atom, a metal atom, and/or a silicon atom.

43. (canceled)

44. A filter media as in claim 41, wherein the one or more polar, non-hydrolysable groups are each independently a side chain of a repeat unit of a polymer.

45. (canceled)

46. A filter media as in claim 41, wherein a ratio of the number of water-repellent functional groups to the number of one or more polar, non-hydrolysable groups is greater than or equal to 0.1 and less than or equal to 10.

47-49. (canceled)

50. A filter media as in claim 1, wherein the non-woven fiber web comprises glass fibers.

51. A filter media as in claim 50, wherein the glass fibers comprise microglass fibers.

52. A filter media as in claim 51, wherein the non-woven web comprises two or more types of microglass fibers having different average diameters.

53-57. (canceled)

58. A filter media as in claim 50, wherein the glass fibers comprise chopped strand glass fibers.

59. (canceled)

60. A filter media as in claim 1, wherein the non-woven fiber web comprises synthetic fibers.

61. (canceled)

62. A filter media as in claim 1, wherein the non-woven fiber web comprises cellulose fibers.

63-72. (canceled)
